(19) United States
(12) Patent Application Publication
(10) Pub. No.: US 2025/0360632 A1
(43) Pub. Date: Nov. 27, 2025

(54) END EFFECTORS FOR MANUFACTURING

(71) Applicant: New Balance Athletics, Inc., Boston, MA (US)

(72) Inventors: Sarah Mendelowitz, Malden, MA (US); Daniel Dempsey, North Andover, MA (US); Bryce Chu, Cambridge, MA (US); Stephen Shepard, Pelham, NH (US); Paul Johnston, Nashua, NH (US); Karl Krantz, Dunstable, MA (US); David Cornell, Salem, MA (US)

(21) Appl. No.: 19/204,074

(22) Filed: May 9, 2025

Related U.S. Application Data
(60) Provisional application No. 63/645,616, filed on May 10, 2024.

(51) Int. Cl. B25J 15/00; B25J 9/16; B25J 15/04; B25J 15/06

(52) U.S. Cl. CPC B25J 15/0052; B25J 9/1697; B25J 15/04; B25J 15/0616

(57) ABSTRACT

A controllable end effector comprising a base component comprising a plurality of motion-defining elements; a plurality of mounting components operatively coupled to the base component, wherein each mounting component is coupled to one of the motion-defining elements; a plurality of drive components each configured to independently control a position of one of the mounting components; and a plurality of pick elements configured to engage with a surface of an object, wherein each mounting component is coupled to at least one of the pick elements. A method of manufacturing using a controllable end effector that includes identifying an object; moving at least two mounting components of the controllable end effector near the object; engaging at least two pick elements coupled to the two mounting components with a surface of the object; moving, via the pick elements, the object; and disengaging the pick elements from the surface of the object.

### CROSS-REFERENCE TO RELATED APPLICATION

This application claims priority to and the benefit of U.S. Provisional Patent Application No. 63/645,616, entitled “END EFFECTORS FOR MANUFACTURING,” filed May 10, 2024, the entire contents of which are incorporated herein by reference.

### FIELD OF THE INVENTION

Embodiments of the present invention relate to end effectors and, more particularly, to controllable end effectors and a method of placement of an object using the same.

### BACKGROUND OF THE INVENTION

In manufacturing, tools can be used to place and position objects to form a manufactured article. Hence, the industry has concentrated on the development of different types of tools that allow for placement and positioning of a number of different types of objects, while adhering to quality control standards for positioning of the objects within the manufactured article. One example of such a tool is an end effector coupled to an end of a robotic element (e.g., robotic arm element), whereby the robotic element controls the position of the end effector to interact with an environment. Using the end effector, the robotic element can handle, manipulate, and sense objects in the environment, thereby allowing the robotic element to perform a task. Some examples of end effectors that can be coupled to a robotic element include process tools (e.g., welding tools, machining tools, painting tools, three-dimensional (3D) printing tools, material removal tools, surface finishing tools, sanding tools, grinding tools, etc.), grippers (e.g., vacuum grippers, needle grippers, electro-adhesive grippers, soft grippers, jamming grippers, etc.), and sensors (e.g., ultrasonic sensors, laser scanners, two-dimensional (2D) and 3D cameras, infrared sensors, etc.). Conventionally, manufacturers have faced challenges when using end effectors to place and position objects having different characteristics, such as objects having differences in stiffness, pliability, dimensions (e.g., shape, size, thickness, etc.), mass, porosity, texture, hardness, and material composition. As an example, techniques used to successfully place and position a first group of objects can cause damage to a second group of objects having characteristics different from the first group of objects. Further, manufacturers have faced challenges in tracking an object's orientation when moving the object between different positions, as manufacturing an article can require manipulation of a range of objects having variable and/or indeterministic dimensions (e.g., based on material flexibility and/or elasticity). For example, in the shoe industry, a wide range of materials need to be manipulated within a single shoe, along with a wide range of sizes/widths of shoes within a single model. Of necessity, when manufacturing an article using automated manufacturing techniques, manufacturers have been limited to using multiple types of end effectors to place and position objects having different characteristics, thereby increasing manufacturing times, increasing costs to maintain and operate multiple types of end effectors, and increasing a number of defects in the manufactured article. When end effectors are not suitable for automated manufacturing of an article, use of manual labor to place and position objects can further increase manufacturing times and a number of defects in the manufactured article (e.g., based on human error).

### SUMMARY OF THE INVENTION

Accordingly, it would be desirable to provide a controllable end effector for placing and positioning objects, whereby the controllable end effector can adapt to and accommodate the characteristics of different objects. In particular, a controllable end effector can include a number of motion-defining elements that are coupled to a number of mounting components. Advantageously, at least one drive component included in the controllable end effector can independently control the positions of the mounting components. Further, the controllable end effector can include a number of pick elements that can engage with (e.g., contact) a surface of an object, where each of the mounting components is coupled to at least one pick element. By controlling positions of the mounting components along the end effector via the motion-defining elements, positions of the pick elements can be modified to accommodate a particular object to be positioned and placed by the end effector (e.g., as a part of a manufacturing process for a manufactured article). For example, the drive components may drive, via the mounting components, a number of pick elements from first positions to second positions according to a position, orientation, stiffness, pliability, dimensions (e.g., shape, size, thickness, etc.), mass, porosity, texture, hardness, and/or material composition of an object to be picked up by the pick elements, thereby allowing the pick elements to engage with a surface of the object to pick up the object and move the object from a first position to a second position. Movement of the object via the controllable end effector can include rotation of the object about one or more axes and/or translation of the object along one or more axes. In some cases, one or more axes about and/or along which an object is moved using the controllable end effector can be x-, y-, and/or z-axes in a Cartesian coordinate system. An example of an object that can be picked and placed using the embodiment of a controllable end effector described herein can include a shaped textile element. A shaped textile element can include a textile fabric element formed as a knit, woven, non-woven, braided, crocheted element, a leather element, or any other porous or non-porous sheet of material having a variety of differing sizes and shapes.

In an aspect, embodiments of the invention relate to a controllable end effector. The controllable end effector includes a base component having a plurality of motion-defining elements; a plurality of mounting components operatively coupled to the base component, where each mounting component is coupled to one of the motion-defining elements; a plurality of drive components, where each drive component is configured to independently control a position of one of the mounting components; and a plurality of pick elements configured to engage with a surface of an object, where each mounting component is coupled to at least one of the pick elements.

One or more of the following features may be included. The plurality of motion-defining elements may include a plurality of tracks. Each mounting component may be coupled to one of the tracks. Each drive component may be configured to independently control the position of one of the mounting components along one of the tracks. In some variations, the base component can include a plate including a central portion and a plurality of arms connected to the central portion, where each of the tracks is attached along one of the arms. Each arm can extend radially from a central axis of the central portion and each track can extend radially from the central axis of the central portion parallel to the respective arm to which the track is attached. In some variations, the arms can be disposed in a single plane. In some variations, at least one of the arms can be releasably connected to the central portion. In some variations, the arms can include a first bent arm and a straight arm, and where the first bent arm can include a bend, a proximal end connected to the central portion, and a distal end extending parallel to the straight arm. The straight arm can be a nearest of the arms to the first bent arm. In some variations, the arms can include a second bent arm. The second bent arm can include a bend, a proximal end connected to the central portion, and a distal end extending parallel to the straight arm. The second bent arm can be disposed opposite the first bent arm with respect to the straight arm. In some variations, the controllable end effector can further include a vacuum tubing connector connected to the central portion. In some variations, the arms can be disposed in more than one plane.

In some variations, the tracks can be disposed in a single plane. In some variations, the tracks can be disposed in more than one plane. At least two of the tracks may be arranged in parallel. At least one of the tracks can include a linear track, where the mounting component coupled to the linear track is traversable along a first axis. At least one of the tracks can include an arcuate track, where the mounting component coupled to the arcuate track is traversable about a first axis.

Each drive component can be configured to translate one of the mounting components to a plurality of positions along one of the tracks and the positions can include a first position at a first end of the track, a second position at a second end of the track, and a plurality of intermediate positions between the first position and the second position. At least two of the tracks can be arranged at an obtuse angle to each other. In some variations, the plurality of tracks can include three tracks and the three tracks can be arranged in a radial pattern at an angle of 120 degrees to each other.

The plurality of motion-defining elements can include a plurality of pivot arms. Each mounting component can be coupled to one of the pivot arms at an end of the pivot arm. Each drive component can be configured to independently control the position of one of the mounting components via one of the pivot arms. In some variations, each mounting component can be traversable along a first axis and a second axis (e.g., orthogonal first and second axes). In some variations, the pivot arms can be disposed in a single plane. In some variations, the pivot arms can be disposed in more than one plane. Advantageously, each drive component can be configured to move one of the mounting components to a plurality of positions via one of the pivot arms and the positions can include a first position, a second position, and a plurality of intermediate positions between the first position and the second position. At least one pivot arm can include a first arm portion and a second arm portion rotationally coupled at a coupling point. In some variations, at least one of the drive components can be configured to move one of the mounting components (i) radially about the coupling point and (ii) rotationally about the end of the pivot arm.

The plurality of motion-defining elements can include a plurality of gears. Each mounting component can be coupled to at least one of the gears. Each drive component can be configured to simultaneously control the position of two or more of the mounting components via at least one of the gears. In some variations, each mounting component is traversable along a single degree of freedom. In some variations, the gears are disposed in a single plane. In some variations, the gears are disposed in more than one plane. Advantageously, each drive component can be configured to move one of the mounting components to a plurality of positions via at least one of the gears and the positions can include a first position, a second position, and a plurality of intermediate positions between the first position and the second position.

Each drive component can be configured to control, via one of the mounting components, a position of the at least one pick element coupled to the mounting component. In some variations, at least one of the mounting components can extend away from a first plane defined by the base component, and at least one of the drive components can be configured to move the at least one of the mounting components along a second plane parallel to the first plane. At least one of the drive components can include: a motor, a piston, a linear actuator, a pneumatic drive component, or a hydraulic drive component.

The controllable end effector can further include a passive compliance component coupled to at least one of the pick elements, where the passive compliance component can be configured to translate along a length of the passive compliance component. In some variations, the passive compliance component can include at least one of a compression spring, a constant force spring, a gas spring, a leveler, a flexure, a counterweight, a bellow, or a spring plunger. In some variations, at least one of the pick elements can include at least one of: a suction cup, a suction source, a fan, a gecko gripper, a mechanical gripper (e.g., needle gripper), an electro-adhesion gripper, or an adhesive gripper. In an example, the pick element can include the suction cup and the suction source, and where the suction cup is fluidically coupled to the suction source (e.g., to apply a relative vacuum via the end of the suction cup). In some variations, the controllable end effector can further include a control element coupled to the suction cup and configured to control contact of the suction source to the object by the suction cup. In an example, the control element can include a valve.

In some aspects, at least a portion of one of the pick elements can be configured to move from a first position to a second position along a central axis of the pick element. In some variations, at least one of the mounting components can include a first central axis, the pick element coupled to the mounting component can include a second central axis, and the first central axis and the second central axis can define an angle therebetween of 0 degrees to 180 degrees. In an example, at least one of the mounting components can define at least one of an “X” shape, a “T” shape, or an “O” shape. In another example, the base component can define at least one of an “X” shape, a “T” shape, or an “O” shape. In some variations, at least one of the mounting components operatively coupled to the base component can be traversable along a first axis. In some variations, at least one of the mounting components operatively coupled to the base component can be traversable along a first axis and a second axis (e.g., orthogonal first and second axes). In some variations, the controllable end effector can further include a calibration attachment coupled to the base component for identifying a position of the controllable end effector.

In some aspects, embodiments of the invention relate to a method of moving an object during a manufacturing process using the controllable end effector. The method can include the steps of identifying an object located at a first positioning; moving a controllable end effector, at least two mounting components coupled to the controllable end effector, and at least two pick elements coupled to the at least two mounting components near the object; engaging the at least two pick elements coupled to the at least two mounting components with a surface of the object; moving, via the at least two pick elements, the object from the first position to a second position different from the first position; and disengaging the at least two pick elements from the surface of the object.

One or more of the following features may be included. In some variations, identifying the object located at the first position can further include generating, by a computer vision system, an image of an environment including the object; identifying the object within the image; comparing the object within the image to a digital representation of the object; determining the object within the image corresponds to the digital representation of the object; and identifying the object located at the first position in response to determining the object within the image corresponds to the digital representation of the object. In some variations, moving the at least two pick elements coupled to the at least two mounting components of the controllable end effector near the object can further include moving the at least two pick elements to respective positions along the controllable end effector in response to identifying the object located at the first position, where each of the at least two pick elements is moved independently; and moving the controllable end effector to a position near the object at the first position in response to identifying the object located at the first position. The respective positions to which the at least two pick elements are moved can be predetermined and based on the object. The respective positions to which the at least two pick elements are moved can be automatically determined based on a digital representation of the object. In some variations, the position near the object at the first position to which the controllable end effector is moved is based on a predetermined position and predetermined orientation of the controllable end effector relative to the object.

In some variations, engaging the at least two pick elements coupled to the at least two mounting components with the surface of the object can further include at least one of activating the at least two pick elements or causing contact between the at least two pick elements and the surface of the object. The second position can be predetermined based on the object (e.g., characteristics of the object). The object can have a predetermined orientation at the second position, where the predetermined orientation is based on the object (e.g., characteristics of the object). In some variations, disengaging the at least two pick elements from the surface of the object can further include at least one of deactivating the at least two pick elements or causing separation between the at least two pick elements and the surface of the object.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of embodiments of the invention. In the following description, various embodiments of the present invention are described with reference to the following drawings, in which:

FIG. 1A is a perspective view of an illustrative controllable end effector with track-based motion-defining elements, in accordance with some embodiments of the invention;

FIG. 1B is a bottom view of the illustrative controllable end effector of FIG. 1A, in accordance with some embodiments of the invention;

FIG. 2A is a perspective view of an illustrative controllable end effector with track-based motion-defining elements, in accordance with some embodiments of the invention;

FIG. 2B is a bottom view of the illustrative controllable end effector of FIG. 2A, in accordance with some embodiments of the invention;

FIG. 3A is a perspective view of a base component of a controllable end effector, in accordance with some embodiments of the invention;

FIG. 3B is a top view of the base component of FIG. 3A, in accordance with some embodiments of the invention;

FIG. 4A is a perspective view of a mounting component, in accordance with some embodiments of the invention;

FIG. 4B is a perspective view of a mounting component, in accordance with some embodiments of the invention;

FIG. 4C is a perspective view of a mounting component, in accordance with some embodiments of the invention;

FIG. 4D is a perspective view of a mounting component, in accordance with some embodiments of the invention;

FIG. 5 is a perspective view of an illustrative controllable end effector with pivot arm-based motion-defining elements, in accordance with some embodiments of the invention;

FIG. 6 is a perspective view of a motion-defining element including a pivot arm, in accordance with some embodiments of the invention;

FIG. 7A is a perspective view of an illustrative controllable end effector with planetary gear-based motion-defining elements, in accordance with some embodiments of the invention;

FIG. 7B is a top view of an illustrative controllable end effector with planetary gear-based motion-defining elements, in accordance with some embodiments of the invention;

FIG. 8 is a perspective view of a motion-defining element including a planetary gear, in accordance with some embodiments of the invention;

FIG. 9A is a perspective view of an illustrative controllable end effector with iris valve-based motion-defining elements, in accordance with some embodiments of the invention;

FIG. 9B is a perspective view of an illustrative controllable end effector with iris valve-based motion-defining elements, in accordance with some embodiments of the invention;

FIG. 10 is a perspective view of a motion-defining element including an iris valve, in accordance with some embodiments of the invention;

FIG. 11 is a perspective view of a pick element including a gecko gripper, in accordance with some embodiments of the invention;

FIG. 12 is a perspective view of a pick element including a mechanical gripper, in accordance with some embodiments of the invention;

FIG. 13 is a perspective view of a pick element including an electro-adhesive gripper, in accordance with some embodiments of the invention;

FIG. 14A is a perspective view of an illustrative controllable end effector with track-based motion-defining elements, in accordance with some embodiments of the invention;

FIG. 14B is a perspective view of the illustrative controllable end effector of FIG. 14A, in accordance with some embodiments of the invention;

FIG. 15 is a perspective view of an illustrative controllable end effector with track-based motion-defining elements and releasable mounting elements, in accordance with some embodiments of the invention;

FIG. 16 is a perspective view of an illustrative releasable arm, in accordance with some embodiments of the invention;

FIG. 17 is a perspective view of an illustrative controllable end effector with a calibration attachment, in accordance with some embodiments of the invention;

FIG. 18 is a flowchart of a method of moving an object using a controllable end effector, in accordance with some embodiments of the invention; and

FIG. 19 is a block diagram of an example computer system, in accordance with some embodiments of the invention.

### DETAILED DESCRIPTION

As a part of a manufacturing process, an end effector can be used to pick and place objects from first (e.g., initial) positions to second (e.g., target) positions within an environment, while translating and/or rotating the objects during movement of the objects from the first positions to the second positions. The end effector can be used to move an object between first and second positions within an environment, with the first position being at a first location, the second position being at a second location, and the first and second locations being different. The end effector can be used to move an object between first and second positions within an environment, with the object having a first orientation at the first position that is the same as or different from a second orientation of the object at the second position. To remedy the deficiencies of conventional end effectors, embodiments of an improved, controllable end effector are provided. A controllable end effector can include a base component, one or more motion-defining elements, one or more mounting components, one or more drive components, and one or more pick elements. In certain examples, a “base component” can refer to a component of the controllable end effector that is couplable to a robotic element (e.g., an end thereof) that moves the end effector within an environment includes and/or is coupled to one or more motion-defining elements. A non-limiting example of a robotic element that moves the end effector within an environment is a robotic arm element that can move (e.g., translate) the controllable end effector (e.g., linearly) along x-, y-, and/or z-axes of motion in a Cartesian coordinate system and/or rotate the controllable end effector about the x-, y-, and/or z-axes of motion. In certain examples, a “motion-defining element” refers to a component of the controllable end effector that enables movement of at least one mounting component relative to the base component. In certain examples, a “mounting component” refers to a component of the controllable end effector that can be operatively coupled to the base component and moved by at least one drive component based on at least one motion-defining element. In certain examples, a “drive component” refers to a component of the controllable end effector that can control a position of at least one mounting component via at least one motion-defining element and cause movement of the at least one mounting component. In certain examples, a “pick element” refers to a component of the controllable end effector that is coupled (e.g., directly coupled) to a mounting component and configured to engage with a surface of an object to be picked up and placed by the controllable end effector. In some variations, a pick element may be configured to contact a surface of an object to move (e.g., by holding and/or lifting) the object from a first position to a second position and/or change an orientation of the object.

In some embodiments, the controllable end effector may position and reposition pick elements used to engage with a surface of an object. Such positioning and repositioning of the pick elements may enable the controllable end effector to pick and place objects having varying characteristics as described herein, thereby expanding application of the controllable end effector to a number of different types of objects. As an example, to pick and place a first object, the controllable end effector may drive a number of pick elements to respective, independently controlled first positions via their coupled mounting components. For the same controllable end effector, to pick and place a second object having characteristics different from the first object, the controllable end effector may drive the pick elements to respective, independently controlled second positions via their coupled mounting components, with at least some of the second positions being different from the first positions. Accordingly, the controllable end effector may adapt the positioning of at least some of the pick elements based on the characteristics of the object to be picked up and placed. Further, a configuration of the base component, motion-defining elements, and/or drive components of the controllable end effector may define the controllable positions of the pick elements.

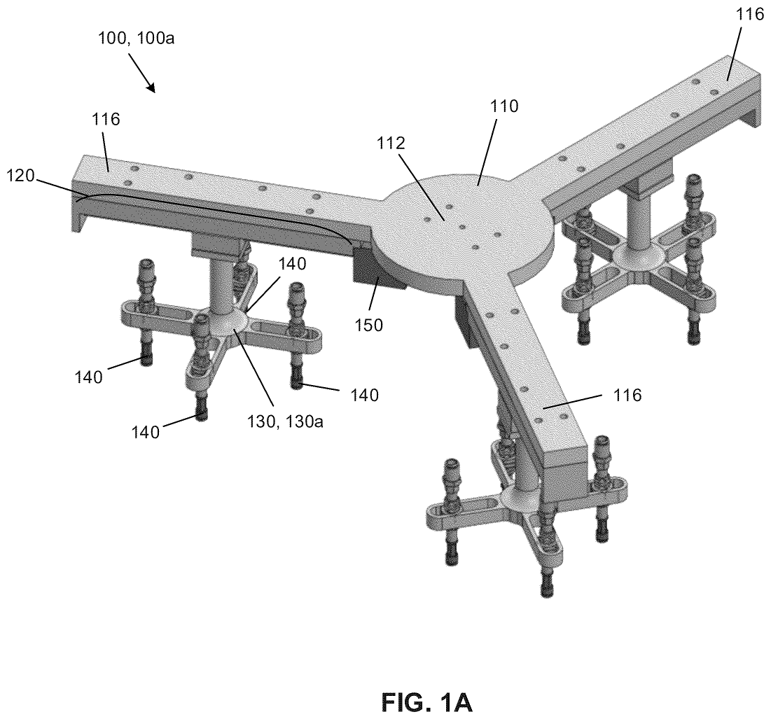

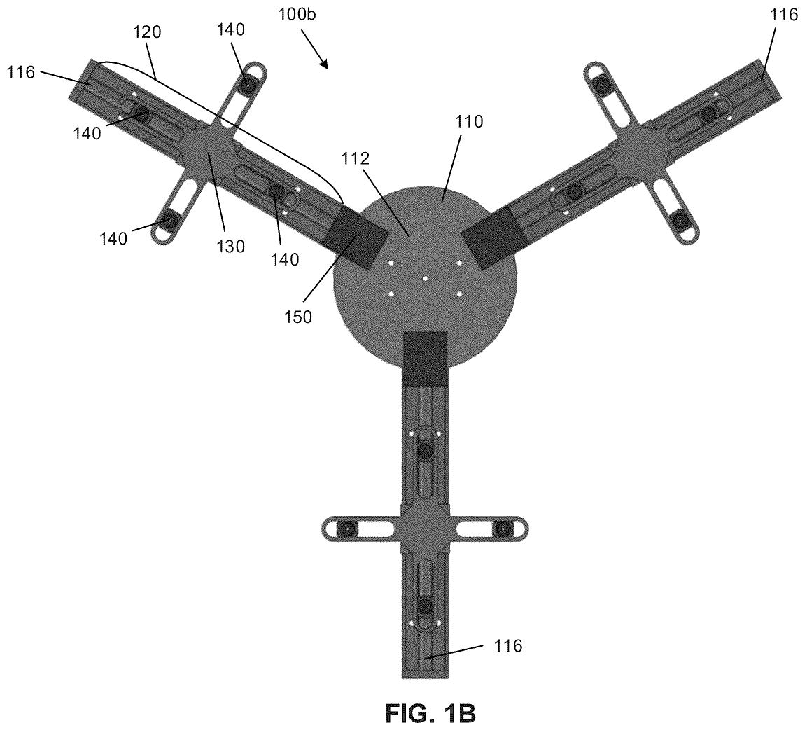

Accordingly, as shown in FIGS. 1A and 1B, an embodiment of a controllable end effector 100, e.g., controllable end effector 100a, includes track-based motion-defining elements. The controllable end effector 100a may include a base component 110, one or more motion-defining elements 120, one or more mounting components 130, e.g., mounting components 130a, one or more pick elements 140, and one or more drive components 150. As shown in the example of FIGS. 1A and 1B, the controllable end effector 100a includes three motion-defining elements, three mounting components, twelve pick elements, and three drive components, with four of the pick elements coupled to each of the mounting components.

In some embodiments, as shown in the example of FIG. 1A, the base component 110 may be a plate, e.g., a metal (e.g., aluminum) frame, including a central portion 112 and a number of arms 116 (e.g., three arms 116) connected to (e.g., extending away from) the central portion 112. In some variations, the base component 110 may have a length between 300 millimeters (mm) and 500 mm, e.g., 402 mm; a width between 300 mm and 500 mm, e.g., 465 mm; and a thickness between 3 mm and 10 mm, e.g., 0.25 inches or 6 mm. In some variations, when the base component 110 includes a central portion 112 and a number of arms 116, the central portion 112 may have a radius between 40 mm and 80 mm, e.g., 60 mm; and an arm 116 may have a length between 50 mm and 300 mm, e.g., 202 mm. One or more of the arms 116 may be a linear arm, an arcuate arm, or a combination thereof. In some variations, an arcuate arm may be and/or define a spiral path, a curved path, a bowed path, or a winding path including two or more curved arcs. The arms 116 may each extend radially from a central axis that extends through the central portion 112 of the base component 110. For example, when the base component 110 includes three arms 116, each arm may extend from a central axis of the base component 110 at an angle of 120 degrees (°) with respect to each of the other arms 116. As shown in FIG. 1A, the arms 116 may be disposed in a single plane. In some variations, the arms 116 may be disposed in more than one plane. For example, a first linear arm 116 may extend parallel to a first axis (e.g., an x-axis in a Cartesian coordinate system), a second linear arm 116 may extend parallel to a second axis (e.g., a y-axis in a Cartesian coordinate system), and a third arcuate arm 116 may be coplanar with a plane formed by the first and second axes (e.g., x- and y-axes in a Cartesian coordinate system). In some cases, the first and second axes may be orthogonal. In some cases, the central axis extending through the central portion 112 may be orthogonal to the plane defined by the first and second axes. In some variations, the base component 110 may include a central portion 112 and may not include any arms 116.

In some embodiments, the base component 110 may be disposed in a single plane. In some variations, the base component 110 may be disposed in more than one plane. The base component 110 may define a shape in a single plane, e.g., a polygon, ellipsoid, or a combination thereof. As shown in FIGS. 1A and 1B, the shape defined by the base component 110 may be a combination of one or more polygons and ellipsoids, such as three rectangles (defined by the arms) extending from a central circle (defined by the central portion). In some variations, the base component 110 may define an “X” shape, an “O” shape, or a “T” shape. The dimensions and shape (e.g., cross-sectional shape) of the base component 110 may be selected based on the type(s) of object(s) to be picked up and placed by the end effector 100a.

The base component 110 of the end effector 100a may be coupled to a robotic element (e.g., robotic arm element) via a coupling mechanism (e.g., screws, clips, threads, magnets, cam lock, mechanical fixtures, pins, adhesive, etc.), with the robotic element being configured to translate and/or rotate the end effector 100a in space within an environment. In some variations, the central portion 112 of the end effector 100a may be coupled to the robotic element. In some variations, one or more arms 116 may be coupled to the robotic element.

In some embodiments, the base component 110 may be coupled to and/or include one or more motion-defining elements 120. Some non-limiting examples of types of motion-defining elements 120 are tracks, lead screws, jack screws, friction drives, cables and pulleys, chucks, collets, rack and pinion mechanisms, pistons, pivot arms, gears (e.g., planetary gears), iris valves, and a combination thereof. As shown in the example of FIGS. 1A and 1B, the motion-defining elements 120 may be tracks that are coupled to (e.g., mounted to) the base component 110 (e.g., via the arms 116), with the base component 110 including three tracks. While FIGS. 1A and 1B illustrate the base component 110 as including only one type of motion-defining element 120 (e.g., tracks), the base component 110 may include more than one type of motion-defining element 120. In some variations, the motion-defining elements 120 may be coupled to the base component 110 by a coupling mechanism (e.g., screws, clips, threads, magnets, cam lock, mechanical fixtures, pins, adhesive, etc.).

In some embodiments, a motion-defining element 120 may be coupled to and/or included in the central portion 112 and/or one or more arms 116. For example, as shown in FIGS. 1A and 1B, each of the motion-defining elements 120 can be attached to a respective one of the arms 116, with each motion-defining element 120 extending radially from the central axis of the central portion 112 parallel to the respective arm 116 to which the motion-defining element 120 is attached. When the end effector 100a includes two or more motion-defining elements 120, at least some of the motion-defining elements 120 may be arranged at an obtuse angle (e.g., >90°) with respect to each other. For example, as shown in FIGS. 1A and 1B, when the base component 110 includes three motion-defining elements 120, the three motion-defining elements 120 may be arranged in a radiating pattern at an angle of 120° with respect to each other. In some variations, when the motion-defining elements 120 are arranged in a radiating pattern from a central axis (e.g., of the central portion 112), the motion-defining elements 120 may be arranged with equal and/or variable angular spacing with respect to each other.

In some embodiments, as shown in FIG. 1A, the motion-defining elements 120 may be disposed in a single plane. In some variations, the motion-defining elements 120 may be disposed in more than one plane. In some variations, one or more of the motion-defining elements may enable linear movement, arcuate movement, or a combination thereof. As shown in FIGS. 1A and 1B, one or more of the motion-defining elements 120 may be linear tracks. An example of a linear track may be a lead screw driven linear stage, whereby the linear stage can be translated along the track (e.g., by a drive component 150) and a mounting component 130 can be coupled to the linear stage (e.g., by a coupling mechanism. In some variations, when at least two of the motion-defining elements 120 are linear tracks, the at least two linear tracks may be arranged in parallel to form an array of two or more linear tracks. In some variations, when the at least two linear tracks are arranged in parallel to form an array of two or more linear tracks, the at least two linear tracks may be disposed in the same plane (e.g., an x-y plane defined by x- and y-axes). In some variations, one or more of the motion-defining elements 120 may be arcuate tracks. In some variations, an arcuate track may be and/or define a spiral, a curved path, a bowed path, or a winding path including two or more curved arcs. In some variations, one or more of the motion-defining elements 120 may be tracks including a linear portion and an arcuate portion.

In some embodiments, a number of mounting components 130 may be operatively coupled to the base component 110. Each mounting component 130 may be coupled to a respective one of the motion-defining elements 120. A particular mounting component 130 may be coupled (e.g., directly coupled) to at least one (e.g., only one) motion-defining element 120. For example, as shown in FIGS. 1A and 1B, a mounting component 130a is coupled to and extends away from a motion-defining element 120 (e.g., track) and the base component 110. In some variations, more than one mounting component 130a may be coupled to a motion-defining element 120. In some variations, one or more of the mounting components 130 may be operatively coupled (e.g., directly coupled) to the base component 110. For example, a mounting component 130 may be fixed to the base component 110, such that mounting component 130 may not be moved (e.g., by a drive component via a corresponding motion-defining element 120).

In some embodiments, as shown in FIGS. 1A and 1B, a mounting component 130a may be moveable (e.g., traversable) along a first axis (e.g., one degree of freedom). As an example, when a mounting component 130a is coupled to a motion-defining element 120 that is a linear track, the mounting component 130 may be traversable along a first axis (e.g., one degree of freedom). Each of the mounting components 130 may be traversable along a single degree of freedom. As an example, when a mounting component 130 is coupled to a motion-defining element 120 that is a linear track, the mounting component 130 may be traversable along a first axis (e.g., one degree of freedom) corresponding to the track. In some variations, a mounting component 130 may be traversable along a first axis and a second axis (e.g., two degrees of freedom). As an example, when a mounting component 130 is coupled to a motion-defining element 120 that is an arcuate track, the mounting component 130 may be traversable along a first axis and a second axis corresponding to the track. In some cases, when a mounting component is traversable along a first axis and a second axis, the first and second axes may be orthogonal. As an example, the first and second axes may be x- and y-axes in a Cartesian coordinate system. As shown in FIG. 1A, one or more of the mounting components 130 may extend away from a plane defined by the base component 110. A mounting component 130 may include a central axis. For example, a central axis of a mounting component 130 may extend away from (e.g., normal to) a plane defined by the base component 110.

In some embodiments, a mounting component 130 may define a polygon, ellipsoid, or a combination thereof. As shown in FIGS. 1A and 1B, a mounting component 130 may define shapes that are a combination of one or more polygons and ellipsoids in a single plane. In some variations, a mounting component 130 may have and/or define an “X” shape, an “O” shape, or a “T” shape; alternatively, a mounting component 130 may be, have, and/or define a single point, a line, or an irregular shape. The dimensions and shape of a mounting component 130 may be selected based on the object(s) to be picked up and placed by the end effector 100a and a preferred configuration of the pick element(s) 140 coupled to the mounting component 130. In some variations, a mounting component 130 may have a length between 20 mm and 40 mm, e.g., 30 mm; a width between 20 mm and 40 mm, e.g., 32 mm; and a height between 20 mm and 40 mm. In some variations, at least a portion of a mounting component 130 may have a thickness between 10 mm and 15 mm, e.g., 13 mm.

In some embodiments, the end effector 100a may be coupled to and/or include one or more drive components 150. Some non-limiting examples of types of drive components 150 can include motors (e.g., stepper motors, servo motors, linear motors, etc.), pistons, linear actuators, rotary actuators, piezoelectric actuators, pneumatic drive components (e.g., pneumatic rotary actuators, pneumatic linear actuators, etc.), magnetic drive components, and hydraulic drive components (e.g., hydraulic cylinders, hydraulic motors, etc.). Each drive component 150 may be configured to independently control (e.g., via direct or indirect coupling) a position of at least one (e.g., only one) of the mounting components 130 (e.g., relative to the base component 110). As an example and as shown in FIGS. 1A and 1B, when the mounting components 130 are linear tracks, drive components 150 may control positions of the mounting components 130 along the tracks, such a first drive component can translate a first mounting component along a first track independently of a second, different drive component that can translate a second, different, mounting component along a second, different track. A computing device (e.g., a controller) communicatively connected to the one or more drive components 150 may control activation of the drive components 150, thereby controlling the positions of the mounting components 130 and enabling movement of the mounting components 130 and pick elements 140 coupled thereto along the tracks. In some variations, a drive component 150 may be configured to translate a mounting component 130 to a number of positions along the motion-defining element 120. As an example, when the motion-defining element 120 is a track, a drive component 150 may be configured to translate a mounting component 130 to a number of positions along the track, with the positions including a first position at a first end of the track, a second position at a second end of the track different from the first end, and a number of intermediate positions between the first position and the second position. As another example, when the motion-defining element 120 is a piston, a drive component 150 may be configured to translate a mounting component 130 to only two positions corresponding to the piston including (i) a first position when the piston is fully extended and (ii) a second position when the piston is fully retracted, where the piston reciprocates between first and second positions.

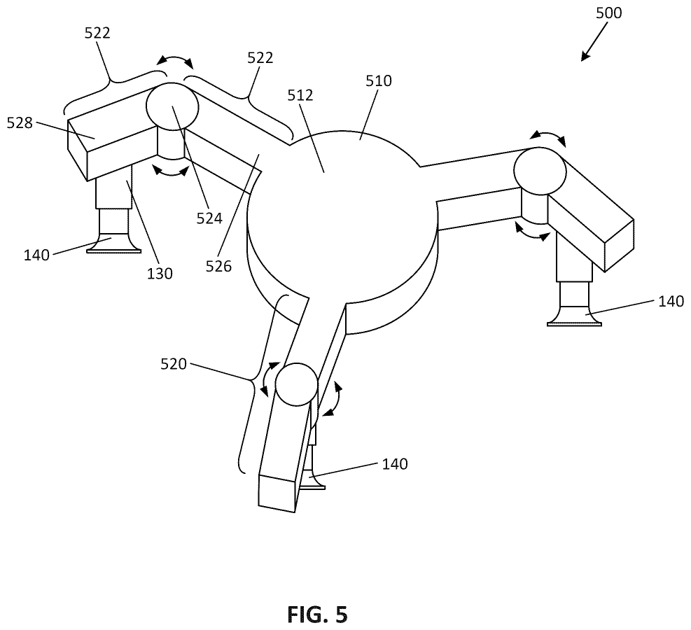

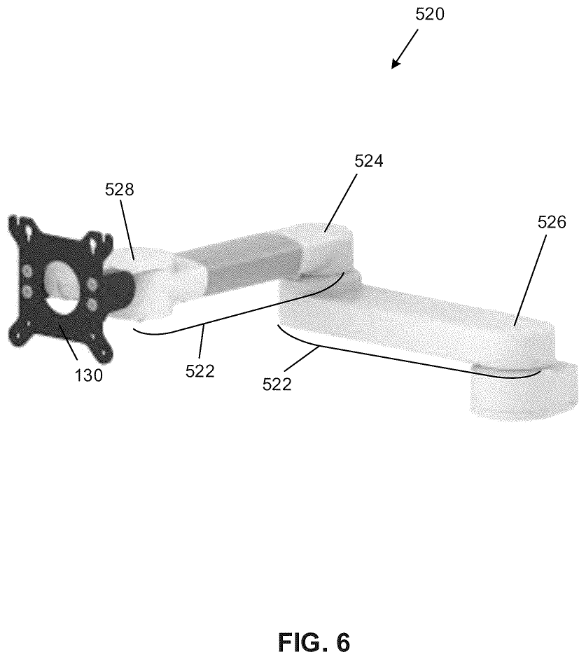

In some embodiments, as described herein, a motion-defining element 120 may be a pivot arm. In some variations, a first end of a pivot arm may be coupled to the base component 110. In some variations, the first end of the pivot arm may be fixedly coupled or rotationally coupled to the base component 110. A pivot arm may include at least two pivot arm portions, with the two pivot arm portions being rotationally coupled at respective ends of the pivot arm portions. The pivot arm portions of the pivot arm may be configured to rotate about a point at which the pivot arm portions are coupled. When a motion-defining element 120 is a pivot arm, a drive component (not shown) may control a position of a mounting component 130 via rotation of the pivot arm, including rotation about the point at which the pivot arm portions of the pivot arm are coupled. An example of a pivot arm is shown with respect to FIGS. 5 and 6.

In some embodiments, a mounting component 130 may be coupled to a pivot arm at a particular location of a pivot arm. As an example, a second end of the pivot arm that is opposite to the first end of the pivot arm coupled to the base component 110 may be coupled to a mounting component 130. The mounting component 130 may be rotationally coupled to the second end of the pivot arm, with the pivot arm being configured to rotate the mounting component 130 about a central axis at a point where the mounting component 130 is coupled to the pivot arm.

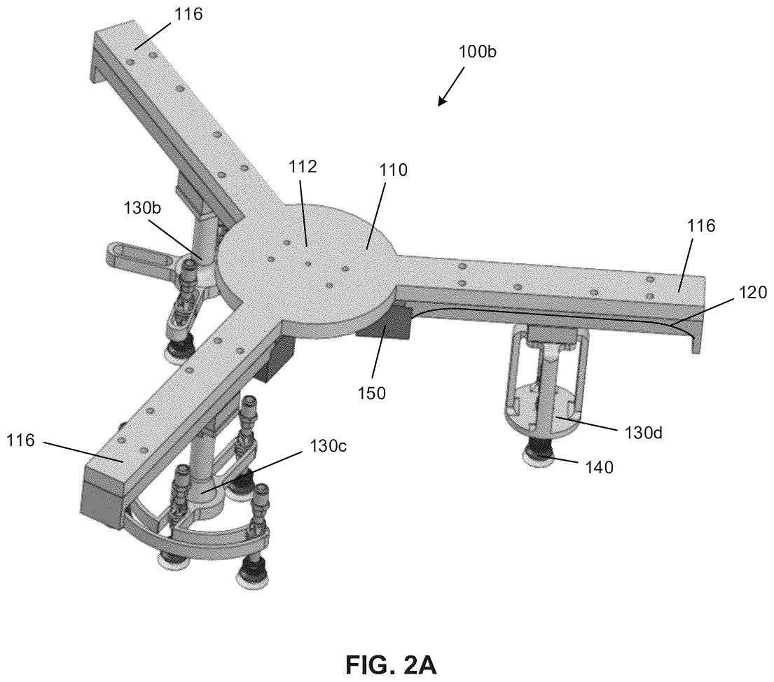

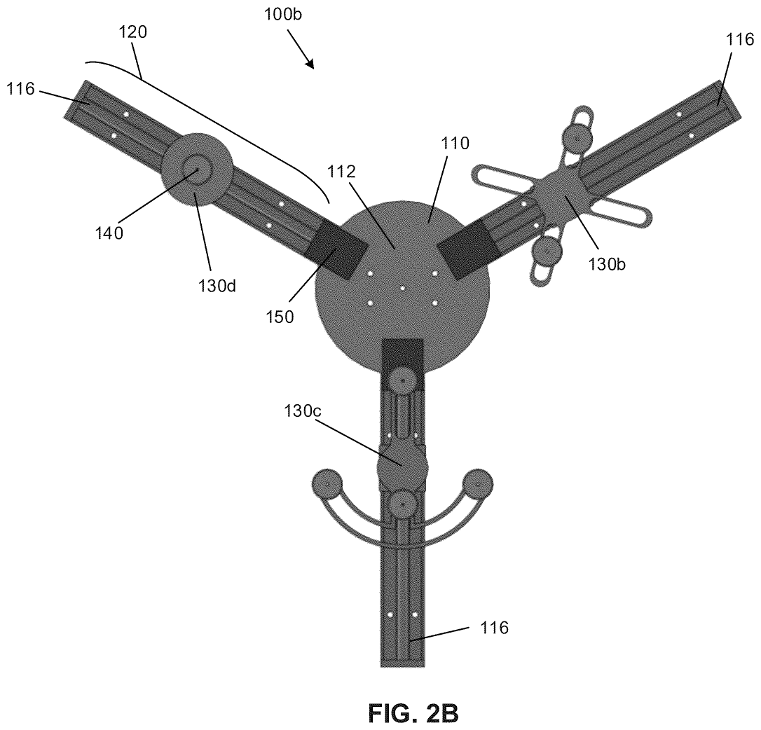

In some embodiments, a drive component may be configured to move a mounting component 130 to a number of positions via the motion-defining element 120. As an example, when the motion-defining element 120 is a pivot arm, a drive component may be configured to move a mounting component 130 to a number of positions including a first position, a second position different from the first position, and a number of intermediate positions between the first position and the second position. Via a pivot arm, one or more drive components may be configured to move a mounting component 130 both radially about an axis at the point at which the pivot arm portions are coupled and rotationally about a central axis at a point where the mounting component 130 is coupled to the pivot arm. In some cases, the axis at the point at which the pivot arm portions are coupled and the central axis at the point where the mounting component 130 is coupled to the pivot arm may be parallel. In some variations, a pivot arm may further include a track (e.g., a linear track, arcuate track, or combination thereof) as described herein (e.g., respect to FIGS. 1A-1B and 2A-2B), such that one or more drive components may be configured to move a mounting component 130 radially about the point at which the pivot arm portions are coupled, rotationally about a central axis at a point where the mounting component 130 is coupled to the pivot arm, and translationally along the track.

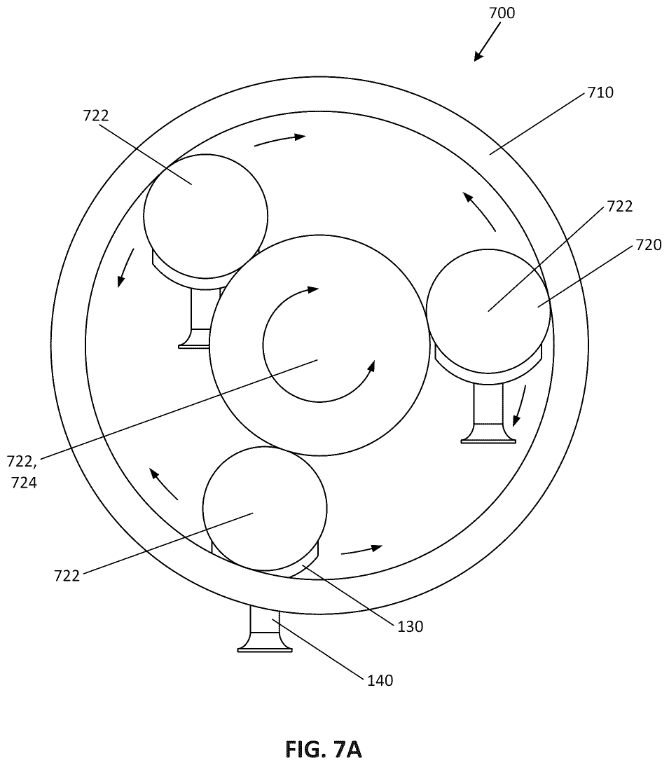

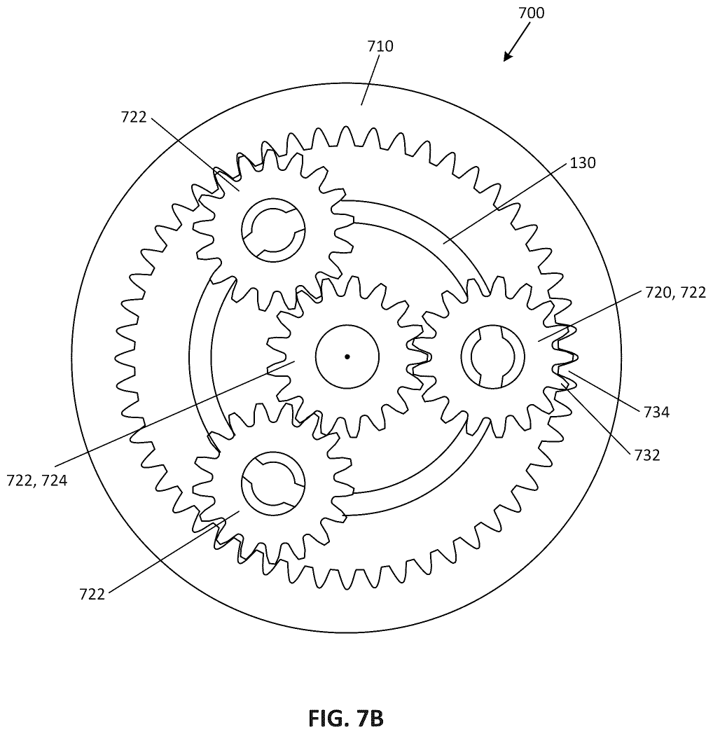

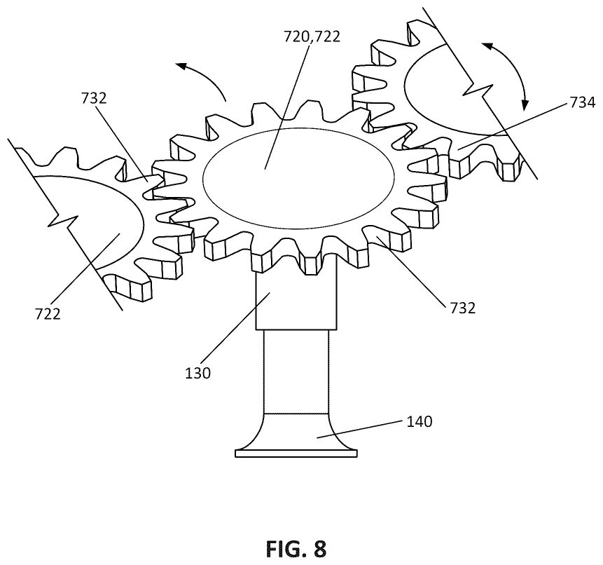

In some embodiments, a motion-defining element 120 may include one or more planetary gears included in and/or coupled to the base component 110. When a motion-defining element 120 includes one or more planetary gears, a mounting component 130 may be coupled (e.g., directly coupled) to one of the planetary gears, and a drive component may simultaneously control a position of one or more of the mounting components 130 via rotation of at least one of the planetary gears. For example, a drive component may cause rotation of a drive gear directly coupled to the drive component, whereby the drive gear causes rotation of one or more planetary gears each coupled to a respective mounting component 130. In some variations, the planetary gears may be disposed in a single plane. In some variations, the planetary gears may be disposed in more than one plane. Examples of planetary gears are shown with respect to FIGS. 7A-7B and 8.

In some embodiments, a drive component may be configured to move a mounting component 130 to a number of positions via the motion-defining element 120. As an example, when the motion-defining element 120 is one or more planetary gears, a drive component may be configured to move a mounting component 130 via the planetary gears to a number of positions including a first position, a second position different from the first position, and a number of intermediate positions between the first position and the second position.

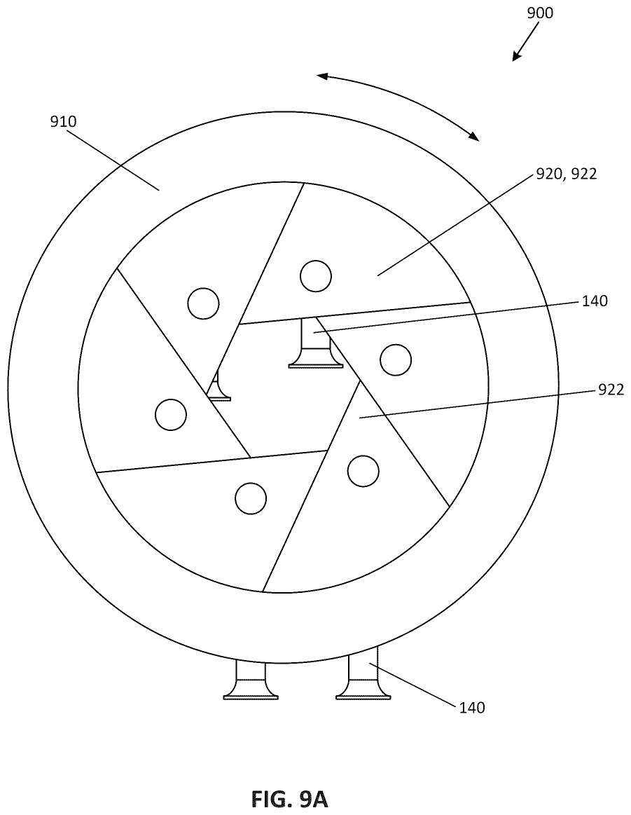

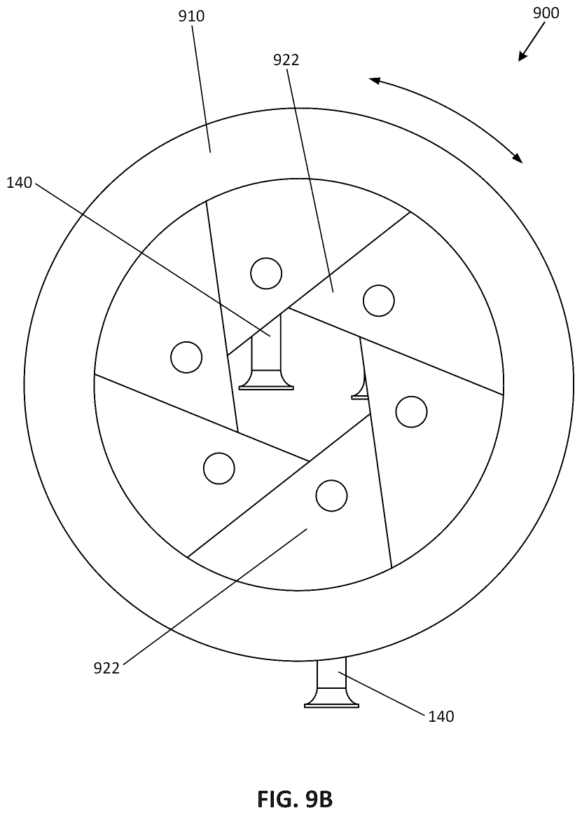

In some embodiments, a motion-defining element 120 may include one or more discrete valve portions of an iris valve included in and/or coupled to the base component 110. Each of the valve portions of the iris valve may be configured to move between a center of the iris valve to an edge of the iris valve. In some variations, each of the one or more discrete valve portions may move between the center of the iris valve to the edge of the iris valve in unison, such that movement of an individual valve portion is dependent on motion of each of the other valve portions. When a motion-defining element 120 includes one or more valve portions of an iris valve, a mounting component 130 may be coupled (e.g., directly coupled) to one of the valve portions, and a drive component may simultaneously control a position of one or more of the mounting components 130 via translation of one or more of the valve portions. In some variations, the valve portions may be disposed in a single plane. In some variations, the valve portions may be disposed in more than one plane. An example of an iris valve is shown with respect to FIGS. 9A-9B and 10.

In some embodiments, a drive component may be configured to move a mounting component 130 to a number of positions via the motion-defining element 120. As an example, when the motion-defining element 120 is one or more valve portions of an iris valve, a drive component may be configured to move a mounting component 130 via one of the valve portions to a number of positions including a first position, a second position different from the first position, and a number of intermediate positions between the first position and the second position.

In some embodiments, as shown in FIGS. 1A and 1B, a mounting component 130 may extend away from a first plane defined by the base component 110. A drive component may be configured to move a mounting component 130 along a second plane, with the second plane being parallel to the first plane defined by the base component 110 (e.g., in which the base component 110 is disposed). For example, a drive component may be configured to move a mounting component 130 along one or two degrees of freedom of a second plane, with the second plane being parallel to the first plane defined by the base component 110.

In some embodiments, the end effector 100a can include one or more pick elements 140 configured to engage with a surface of an object. A pick element 140 may be configured to engage with a number of objects having variable characteristics. In some cases, a computing device (e.g., controller) may be configured to independently control engagement of the one or more pick elements 140 with a surface of an object. By engaging with a surface of an object, the pick element(s) 140 may be configured to pick and place the object from a first (e.g., initial) position to a second (e.g., target) position, while controlling the orientation of the object placed at the second position. In some variations, a pick element 140 may have a height between 0.1 mm and 100 mm, e.g., 80 mm; a length between 0.1 mm and 130 mm, e.g., 114 mm; and a width between 0.1 mm and 130 mm, e.g., 114 mm. Some non-limiting examples of types of pick elements can include suction cups, suction sources (e.g., vacuum sources such as vacuum generators), fans, gecko grippers, mechanical (e.g., robotic, needle, etc.) grippers, electro-adhesive (e.g., electro-static) grippers, and adhesive grippers. An example of a suitable suction cup is vacuum cup provided by MCMASTER having a diameter of 0.31 inches, a height of 0.28 inches, and a compressed height of 0.22 inches. The suction cup may have a suction capacity of 0.51 pounds at 24 inches of Hg when connected to a vacuum source (e.g., vacuum generator). In some cases, a suction cup may be coupled to a mounting component 130 via a mounting thread coupled to each of the suction cup and the mounting component 130.

In some embodiments, each mounting component 130 may be coupled to at least one pick element 140. In some variations, a mounting component 130 may be coupled to more than one pick element 140. In some variations, a mounting component 130 and at least one pick element 140 may be integrated (e.g., combined) and connected to a motion-defining element 120. A number of pick elements coupled to a mounting component 130 may be selected based on an object to be picked up and placed by the end effector 100. Each drive component may be configured to control, via a mounting component 130, a position of the at least one pick element coupled to the mounting component 130. For example, as shown in FIGS. 1A and 1B, a drive component 150 may control, via a mounting component 130a, a position of four separate pick elements 140 coupled to the mounting component 130a. Because of the coupling between a mounting component 130 and a pick element 140, the pick element 140 may move with the mounting component 130 as the mounting component 130 is moved, such that the pick element 140 moves in unison with the mounting component 130 (e.g., via a drive component 150) to which it is coupled.

In some embodiments, to accommodate objects having variable heights, a pick element 140 may be configured to move from a first position to a second position along a central axis of the pick element. As shown in FIGS. 1A, a central axis of a pick element 140 may be normal to a plane defined by the base component 110 and a plane defined by the mounting component 130 to which the pick element 140 is coupled. In some cases, when a pick element is moveable along a first axis, the central axis of a pick element 140 may be orthogonal to the first axis. In some cases, when a pick element is moveable along first and second axes, the central axis of a pick element 140 may be orthogonal to both the first and second axes. In some variations, as described herein, a mounting component 130 may include a central axis. A first central axis of a mounting component 130 and a second central axis of a pick element 140 to which the mounting component 130 is coupled may be arranged at an angle of 0° to 180°, such that the first central axis and the second central axis define an angle therebetween of 0° to 180° based on an orientation in which a pick element 140 is coupled to a mounting component 130.

In some embodiments, an end effector 100a may include a passive compliance component coupled to a pick element 140. The passive compliance component may be configured to move along a length (e.g., central axis) of the passive compliance component, thereby enabling the pick element 140 to accommodate objects having variable heights. In some cases, when the pick element is moveable along a first axis, the length of the passive compliance component along which the passive compliance component is configured to move may be orthogonal to the first axis. In some cases, when the pick element is moveable along first and second axes, the length of the passive compliance component along which the passive compliance component is configured to move may be orthogonal to the first and second axes. Some non-limiting examples of suitable passive compliance components include compression springs, constant force springs, gas springs, levelers, flexures, counterweights, bellows, and spring plungers. An example of a leveler is a vacuum cup leveler provided by MCMASTER having a stroke length 0.375 inches with a 0.3125 inch diameter, thereby enabling the leveler to translate 0.375 inches along a length of the leveler.

In some embodiments, when a pick element 140 includes a suction cup, the end effector 100a can include a suction source (e.g., vacuum source) fluidically coupled to the suction cup. The suction source fluidically coupled to the suction cup may be configured to generate a relative vacuum at the suction cup. In some variations, a suction cup may be fluidically coupled via tubing to a vacuum generator, such as a VGS™ 5010 vacuum generator provided by PIAB. The vacuum generator may be coupled, for example, to a 60 megapascal (MPa) compressed air supply. A maximum feed pressure of the vacuum generator may be 101.5 pounds per square inch (PSI). In some variations, the vacuum generator may be based on the Bernoulli principle, the Coanda effect, and/or the Venturi effect; in some embodiments, the vacuum generator can include a vacuum pump. A suitable vacuum generator is a vacuum ejector configured to generate a vacuum (e.g., relative vacuum) based on the Venturi effect. In some variations, the end effector 100a can include a control element coupled to the suction cup, whereby the control element is configured to control application of a vacuum generated by the suction source to a surface of the object via the suction cup. As an example, the control element may be a valve. An example of a valve is a solenoid valve provided by GRANGER having a 0.25 inch pipe size with a 2-way/2-position valve. The valve may control (e.g., turn on or turn off) application of a vacuum generated by the vacuum generator to a suction cup. In some variations, the control element may be controlled by a computing device (e.g., controller), such that the computing device can control application of the vacuum generated by the vacuum generator to the suction cup via the control element.

Referring to FIGS. 2A and 2B, an embodiment of a controllable end effector 100b including track-based motion-defining elements is shown. The controllable end effector 100b may include a base component 110, one or more motion-defining elements 120, one or more mounting components 130b, 130c, 130d, and one or more pick elements 140. The controllable end effector 100b may further include one or more drive components 150. As shown in FIGS. 2A and 2B, a controllable end effector 100b may include multiple types of mounting components 130b, 130c, 130d. Different types of mounting components 130 included in the controllable end effector 100 may be coupled (e.g., directly coupled) to different numbers of pick elements 140.

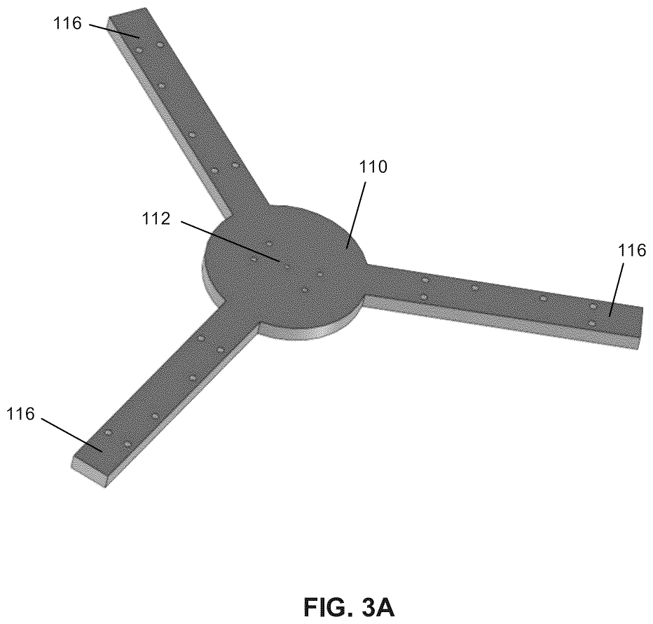

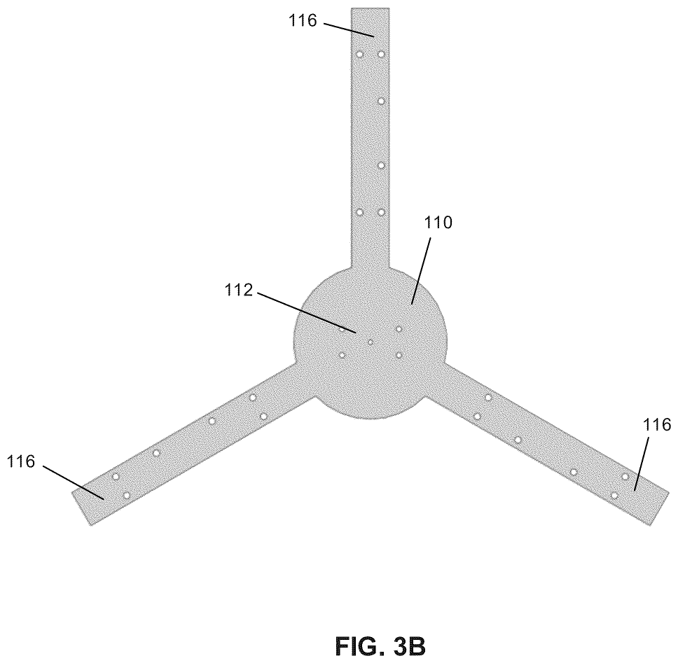

Referring to FIGS. 3A and 3B, an embodiment of the base component 110 is shown. The base component may include a central portion 112 and a number of arms 116 (e.g., three arms 116) connected to (e.g., extending away from) the central portion 112. Referring also to FIGS. 1A and 1B, the base component 110 may be coupled to and/or include one or more motion-defining elements 120, e.g., coupled to and/or included in the central portion 112 and/or the one or more arms 116. For example, the base component 110 may include linear tracks coupled to the arms 116.

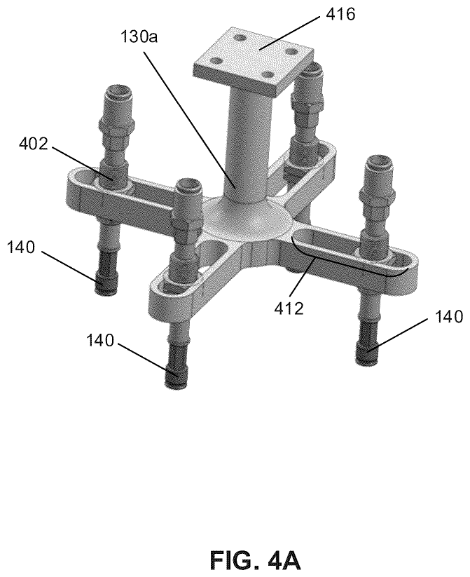

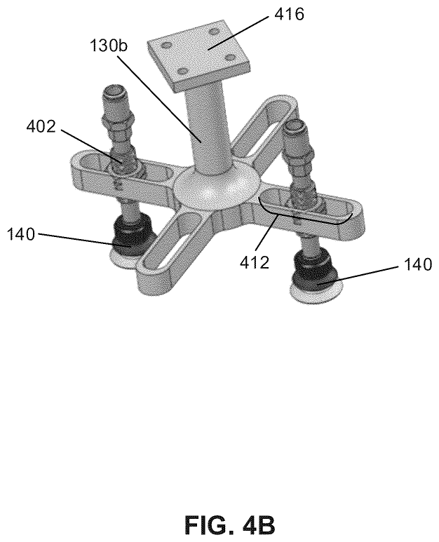

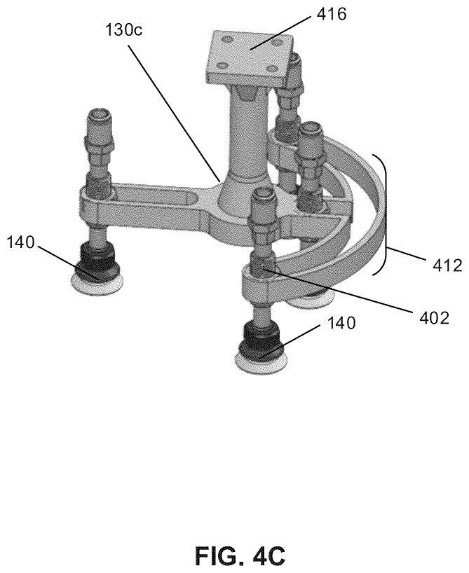

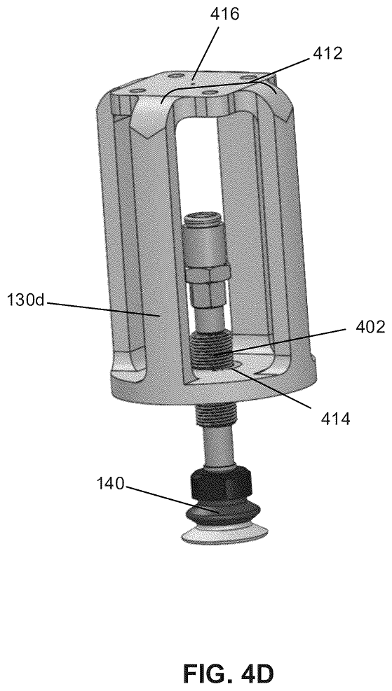

Referring to FIGS. 4A, 4B, 4C, and 4D, embodiments of mounting components 130 are shown. As shown in FIG. 4A, a mounting component 130a may include one or more voids 412 defined by a frame of the mounting component, with one or more pick elements 140 coupled to the mounting component 130a through the voids 412. The void 412 may be a linear void, an arcuate void, or a combination thereof. In the example of FIG. 4A, each void 412 includes one pick element 140, with the pick element 140 being coupled to the mounting component 130a by a mounting thread 402 positioned within the void 412. A position of a pick element 140 along a void defined by a mounting component may be adjusted (e.g., automatically adjusted by an adjustment mechanism and/or manually adjusted by a user of the mounting component 130a) using the mounting thread 402 coupled to the pick element 140. In some variations, as shown in FIG. 4A, the voids 412 may be positioned with respect to each other to define an “X” shape.

In some embodiments, as shown in FIG. 4B, a mounting component 130b may include one or more linear voids 412. In some variations, the linear voids 412 may be positioned with respect to each other to define an “X” shape.

In some embodiments, as shown in FIG. 4C, a mounting component 130c may include a linear void as well as a void 412 including a combination of an arcuate void and a linear void. Accordingly, as shown in the example of FIG. 4C, a single void 412 may accommodate three pick elements 140 coupled to the mounting component 130c by respective mounting threads 402 positioned within the void 412.

In some embodiments, as shown in FIG. 4D, a mounting component 130d may define a vertical bore 414 surrounded by four voids 412. In the example of FIG. 4D, the pick element 140 is coupled to the mounting component 130d by the mounting thread 402 positioned within the vertical bore 414.

Referring to FIG. 5, an embodiment of a controllable end effector 500 including pivot arm-based motion-defining elements is shown. The controllable end effector 500 may include a base component 510, one or more motion-defining elements 520, one or more mounting components 130, and one or more pick elements 140. The controllable end effector 500 may further include one or more drive components (not shown in FIG. 5). As shown in FIG. 5, a controllable end effector 500 may include base component 510 having a central portion 512.

In some embodiments, the motion-defining element 520 may be a pivot arm. In some variations, a first end of a pivot arm may be coupled (e.g., rotationally coupled) to and/or included in the base component 510. A pivot arm may include at least two pivot arm portions 522, with the two pivot arm portions 522 being rotationally coupled at a coupling point 524 at respective ends of the pivot arm portions. In some variations, the pivot arm portions 522 may have the same length or different lengths. The pivot arm portions 522 of the pivot arm may be configured to rotate about the point 524 at which the pivot arm portions 522 are coupled. When a motion-defining element 520 is a pivot arm, a drive component (not shown) may control a position of a mounting component 130 via rotation of the pivot arm, including rotation of a pivot arm portion 522 about the point 524 at which the pivot arm portions 522 of the pivot arm are coupled.

In some embodiments, a mounting component 130 may be coupled to a pivot arm at a particular location of a pivot arm. As an example, a second end 528 of the pivot arm that is opposite to the first end 526 of the pivot arm coupled to the base component 510 may be coupled to a mounting component 130. The mounting component 130 may be rotationally coupled to the second end 528 of the pivot arm, with the pivot arm being configured to rotate the mounting component 130 about a central axis at a point where the mounting component 130 is coupled to the pivot arm.

In some embodiments, a drive component may be configured to move a mounting component 130 to a number of positions via the motion-defining element 520. As an example, when the motion-defining element 520 is a pivot arm, a drive component may be configured to move a mounting component 130 to a number of positions including a first position, a second position, and a number of intermediate positions between the first position and the second position. Via a pivot arm, one or more drive components may be configured to move a mounting component 130 both radially about the point 524 at which the pivot arm portions are coupled and rotationally about a central axis at a point (e.g., a second end 528 of the pivot arm) where the mounting component 130 is coupled to the pivot arm. Referring to FIG. 6, an illustrative embodiment of a motion-defining element 520 including a pivot arm is shown.

Referring to FIGS. 7A and 7B, an embodiment of a controllable end effector 700 including planetary gear-based motion-defining elements is shown. The controllable end effector 700 may include a base component 710, one or more motion-defining elements 720, one or more mounting components 130, and one or more pick elements 140. The controllable end effector 700 may further include one or more drive components (not shown in FIGS. 7A and 7B). As shown in FIGS. 7A and 7B, a controllable end effector 700 may include base component 710 coupled to motion-defining elements 720 including one or more planetary gears 722. Referring to FIG. 8, an embodiment of a motion-defining element 720 including a planetary gear 722 is shown.

In some embodiments, a motion-defining element 720 may include one or more planetary gears 722 included in and/or coupled to the base component 710. When a motion-defining element 720 includes one or more planetary gears 722, a mounting component 130 may be coupled (e.g., directly coupled) to one or more of (e.g., each of) the planetary gears 722, and a drive component may simultaneously control a position of one or more of the mounting components 130 via rotation of the at least one of the planetary gears 722. For example, a drive component may cause rotation of a drive gear 724 directly coupled to the drive component, whereby the drive gear 724 causes rotation of one or more planetary gears 722 each coupled to a respective mounting component 130. In some variations, the planetary gears 722 may be disposed in a single plane. In some variations, the planetary gears 722 may be disposed in more than one plane. The base component may include a coupling mechanism by which the planetary gears may move the base component 710. For example, the base component 710 may include a number of first complementary structures 734 (e.g., teeth, ridges, etc.) configured to accommodate a number of second complementary structures 732 (e.g., teeth, ridges, etc.) of the planetary gears 722.

In some embodiments, a drive component may be configured to move (e.g., rotate) a mounting component 130 to a number of positions via the motion-defining element 720. As an example, when the motion-defining element 720 is one or more planetary gears 722, a drive component may be configured to move a mounting component 130 via the planetary gears 722 to a number of positions including a first position, a second position different from the first position, and a number of intermediate positions between the first position and the second position. The drive component may simultaneously move the mounting components 130 by causing rotation of one or more of the planetary gears 722.

Referring to FIGS. 9A and 9B, an embodiment of a controllable end effector 900 including iris valve-based motion-defining elements is shown. The controllable end effector 900 may include a base component 910, one or more motion-defining elements 920, one or more mounting components (not shown in FIGS. 9A and 9B), and one or more pick elements 140. The controllable end effector 900 may further include one or more drive components (not shown in FIG. 9). As shown in FIG. 9, a controllable end effector 900 may include base component 910 coupled to motion-defining elements 920 including one or more valve portions 922 that form an iris valve.

In some embodiments, a motion-defining element 920 may include one or more discrete valve portions 922 of an iris value included in and/or coupled to the base component 910. Each of the valve portions 922 of the iris valve may be configured to move between a center of the iris valve an edge of the iris valve (e.g., defined by the base component 910). As shown in FIG. 9A, the valve portions 922 may be positioned closer to a center of the iris valve. As shown in FIG. 9B, the valve portions 922 may be positioned further from a center of the iris valve and closer to the base component 910. When a motion-defining element 920 includes one or more valve portions 922 of an iris valve, a mounting component 130 may be coupled (e.g., directly coupled) to one of the valve portions 922, and a drive component may simultaneously control a position of one or more of the mounting components 130 via translation of one or more of the valve portions 922. In some variations, the valve portions 922 may be disposed in a single plane. In some variations, the valve portions 922 may be disposed in more than one plane. Referring to FIG. 10, a motion-defining element 920 including an iris valve having a number of valve portions 922 is shown.

In some embodiments, a drive component may be configured to move a mounting component 130 to a number of positions via the motion-defining element 920. As an example, when the motion-defining element 920 is one or more valve portions 922 of an iris valve, a drive component may be configured to move a mounting component 130 via one of the valve portions 922 to a number of positions including a first position, a second position different from the first position, and a number of intermediate positions between the first position and the second position.

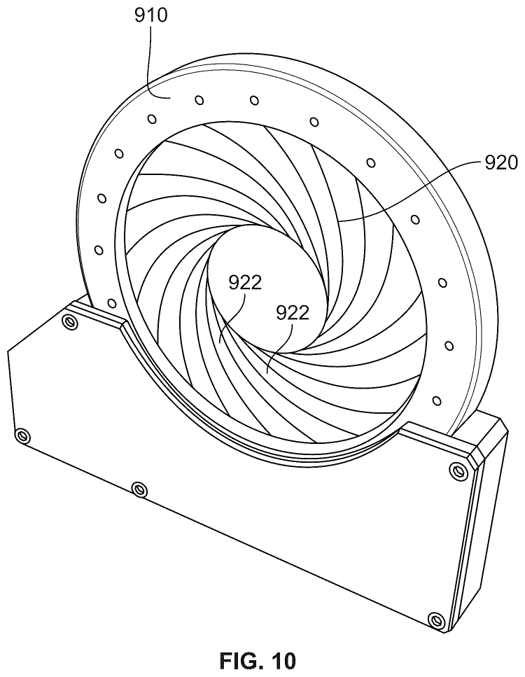

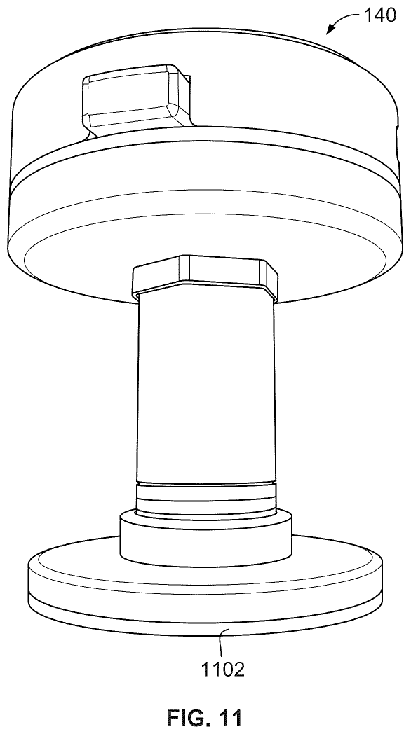

Referring to FIG. 11, a pick element 140 including a gecko gripper is shown. The gecko gripper can include a gripping portion 1102 configured to engage with a surface of an object. The gripping portion 1102 may include a plurality of filament structures configured to grip (e.g., adhere to) a surface of an object, such that the gripping portion 1102 can engage with a surface of the object and enable movement of the object from a first position to a second position. In some variations, Van der Waal forces may enable the filament structures to pick and place objects. An example of a suitable gecko gripper is a Compact No-M ark Gecko Gripper provided by ONROBOT.

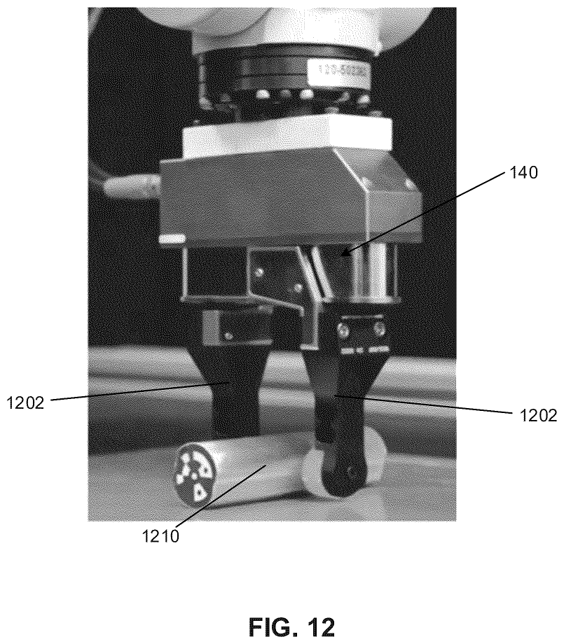

Referring to FIG. 12, a pick element 140 including a mechanical, robotic gripper is shown. The robotic gripper can include one or more mechanical gripping portions 1202 configured to engage with a surface of an object 1210. In the example shown in FIG. 12, the robotic gripper includes two mechanical gripping portions 1202, with the gripping portions 1202 being configured to move to engage with a surface of the object 1210 and enable movement of the object 1210 from a first position to a second position.

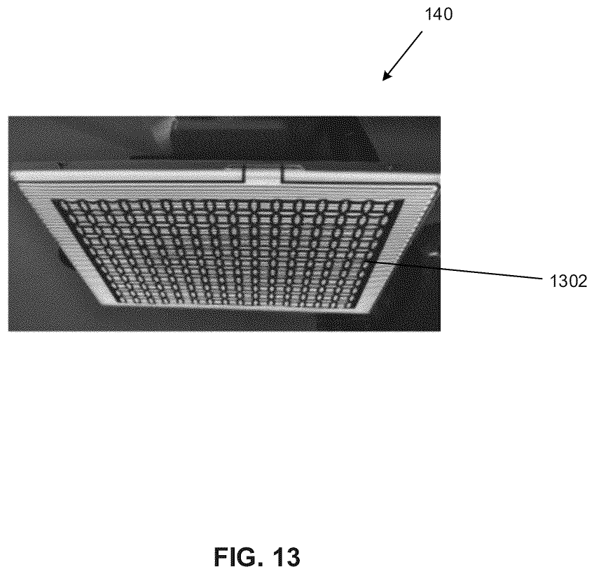

Referring to FIG. 13, a pick element 140 including an electro-adhesive gripper is shown. The electro-adhesive gripper can include one or more electro-adhesion portions 1302 configured to engage with a surface of an object via electro-static charge. In the example shown in FIG. 12, the electro-adhesive gripper includes a grid of electro-adhesion portions. The grid may produce an electro-static charge to cause a surface of an object to adhere to the grid and the pick element 140, such that the object can be moved from a first position to a second position.

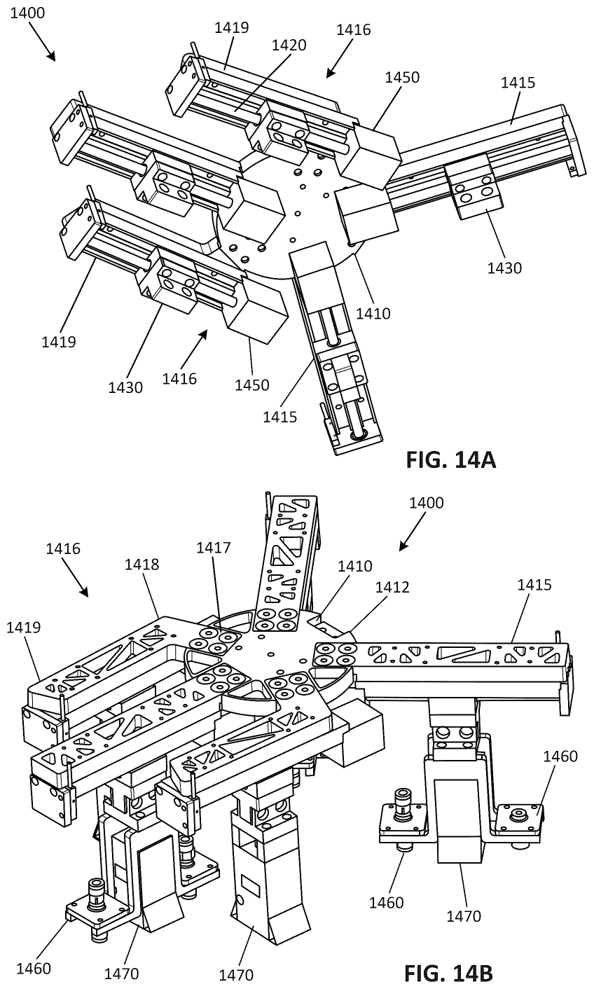

Referring to FIGS. 14A and 14B, another example controllable end effector 1400 is shown. A bottom perspective view of the controllable end effector 1400 is shown in FIG. 14A. A top perspective view of the controllable end effector 1400 is shown in FIG. 14B. In this embodiment, the controllable end effector 1400 includes a base component 1410 having a central portion 1412 with five arms extending therefrom. The arms include three straight arms 1415 extending radially from (e.g., a center of) the central portion 1412, with two additional bent arms 1416 extending on either side of one of the straight arms 1415. Each of the bent arms 1416 can include a bend 1418 such that proximal ends 1417 of the bent arms 1416 are connected to the central portion 1412 and the bent arms extend radially from (e.g., a center of) the central portion 1412. The distal ends 1419 of the bent arms 1416 extend parallel to, and on each side of, the nearest straight arm 1415. As a result, a plurality of mounting components 1430 and any pick elements attached thereto can be moved in parallel by the drive components 1450 and motion defining elements 1420 attached to each arm.

In various embodiments, any combination of straight arms 1415 and bent arms 1416 can extend from the central portion 1412 with the straight arms 1415 extending at any angle from (e.g., a center of) the central portion 1412. The bent arms 1416 may be arranged such that each distal end 1419 thereof can be configured to move mounting components 1430 and the attached pick elements in any appropriate arrangement of linear (e.g., straight) or curved paths, thereby allowing the pick elements to adapt to pick-up and accurately place a wide variety of objects such as, but not limited to, a shaped textile element (e.g., a textile fabric element formed as a knit, woven, non-woven, braided, crocheted element, a leather element, or any other porous or non-porous sheet of material) having a variety of differing sizes and shapes.

In the example embodiment of FIG. 14B, the pick elements mounted to each mounting component 1430 can include one or more suction cups 1460 and/or needle grippers 1470, with the needle grippers 1470 including a number of needle elements that can be extended and retracted at an angle to a plane of (e.g., defined by) the object being picked-up such that the needles can extend into the object (e.g., a porous textile element) to hold the object to the pick element 1440 to move the object, after which the needles can be retracted to release the object at a desired position and orientation.

Depending upon the specific requirements of each pick element, the pick element can include only a needle gripper 1470, or include a needle gripper 1470 with two suction cups 1460 mounted to either side (e.g., on opposite sides of the needle gripper 1470) to provide an additional and/or alternative picking mechanism. In alternative embodiments, any combination and arrangement of pick elements may be utilized.

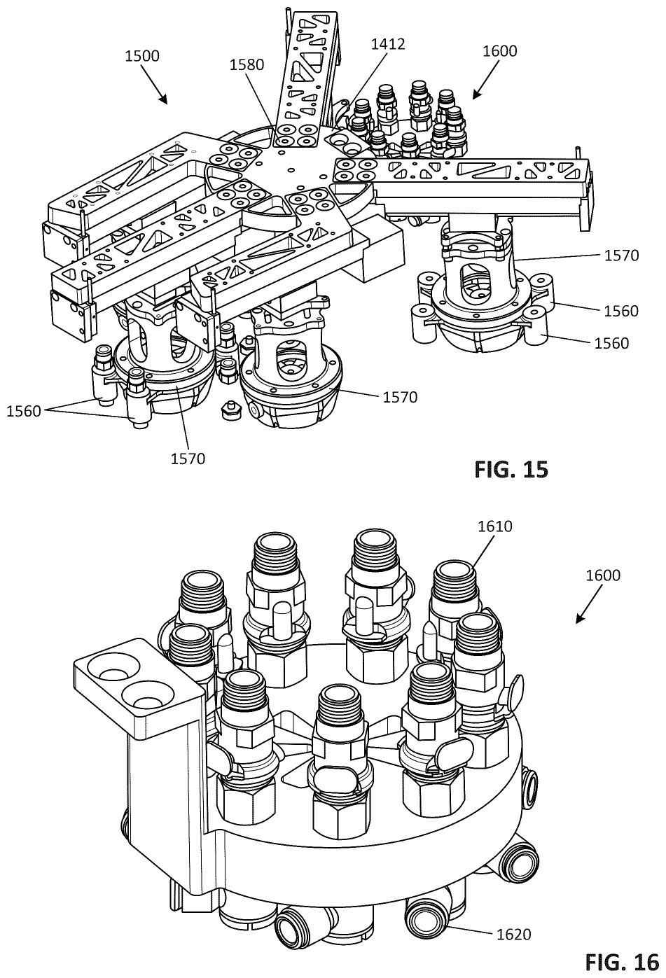

For example, FIG. 15 shows a top perspective view of a controllable end effector 1500 having pick elements including partial vacuum pick elements 1570 that utilize the Coanda effect to provide a suction force to releasably pick up and release an object. In some cases, some of the vacuum pick elements 1570 can have a number of suction cups 1560 mounted around a rim of the vacuum pick elements 1570 to provide an additional and/or alternative picking mechanism.

In one embodiment, the central portion 1412 can be configured with releasable mounting elements 1580 (such as, but not limited to, screw attachment elements, magnetic attachment elements, or the like) to allow one or more arms to be removably coupled (e.g., releasably mounted) to the central portion 1412, thereby allowing the arms to be replaced with differently shaped or sized arms to reconfigure the controllable end effector 1500 to pick up different sizes, shapes, and/or constructions of objects. In an alternative embodiment, the arms may be permanently attached to the central portion 1412.

In one embodiment, as shown in FIG. 16, a vacuum tubing connector 1600 can be mounted to the controllable end effector to provide a hub for connecting one or more vacuum sources to each of the pick elements requiring such a source for operation. The vacuum tubing connector 1600 includes a number of quick release valves 1610 that can be releasably attached to a hose connecting the quick release valves 1610 to a vacuum source.

The quick release valves 1610 can each connect to a hose mount 1620 configured to attach to a proximal end of a second hose (not shown), with the distal end of each second hose connecting to an appropriate pick element (e.g., a suction cup 1560 or a vacuum pick element 1570).

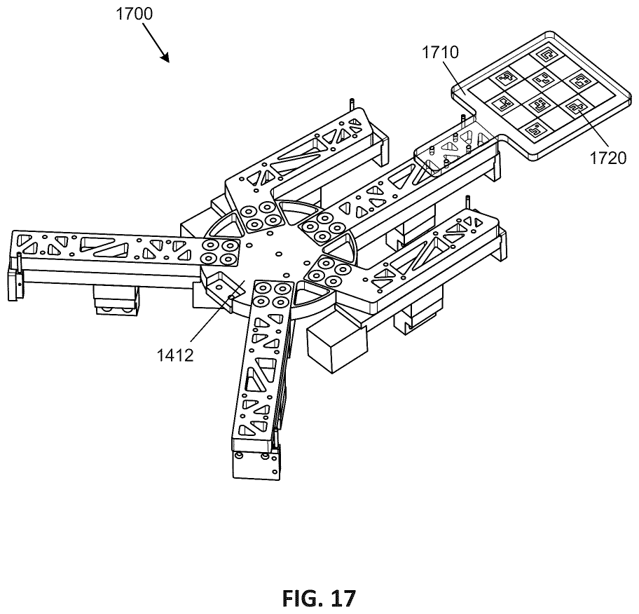

In some embodiments, a controllable end effector and/or a robotic element to which the controllable end effector is coupled can include one or more calibration attachments including one or more visual indicators by which a computer vision system can identify a location of the controllable end effector and/or the robotic element within the environment. Referring to FIG. 17, a controllable end effector 1700 can include a calibration attachment 1710 with one or more visual indicators 1720. In some cases, the calibration attachment can be permanently or releasably mounted to the central portion 1412, an arm, or a motion-defining element of the controllable end effector. The controllable end effector can include one or more calibration attachments. By identifying the calibration attachment and at least some of the visual indicators included thereon, a computer vision system can identify a location of the controllable end effector, the robotic element, and/or portions thereof within the environment and provide such location information to the controller for use in determining positions to which to move the controllable end effector and/or pick elements coupled thereto (e.g., in relation to an object to be picked and placed).

In some embodiments, embodiments of the controllable end effector described herein may be coupled to a robotic element and used to move (e.g., translate and/or rotate) an object from a first, initial position to a second, target position different from the first position. In some variations, embodiments of the controllable end effector described herein may be coupled to a robotic element and used to hold and lift an object between the first position and second position. The controllable end effector may be used to move an object as a part of a manufacturing process (e.g., for manufacturing an article, such as athletic apparel or an article of footwear). A computing system may be used to control the robotic element and the controllable end effector, thereby moving a picked up object from a first position to a second position. In some cases, the computing system may include a controller computing device (also referred to as a “controller”) and a computer vision system. In some cases, the controller may include a programmable logic controller (PLC). The controller may control a position and an orientation for the controllable end effector, the components of the controllable end effector, and/or a robotic element to which the controllable end effector is coupled. Some examples of components of the controllable end effector that can be controlled by the controller are the drive components and pick elements. The controller may control movement of the mounting components and pick elements coupled thereto via the drive components. The controller may control activation of pick elements of the controllable end effector to cause the pick elements to engage with or disengage with a surface of an object. In some variations, the controller may control a position and orientation of the controller end effector within the environment as described herein based on one or more communications received from the computer vision system, such as images acquired by the computer vision system. The computer vision system may be configured to detect (i) an object to be picked up by the controllable end effector and (ii) an environment in which the controllable end effector operates and provide such information to the controller. In some variations, the computer vision system may include one or more sensors configured to generate an image of an environment and objects included therein. Some non-limiting examples of the sensors of the computer vision system used to generate an image of an environment and objects included therein can include a camera, a light detection and ranging (LiDAR) sensor, an ultrasonic sensor, a laser depth sensor, a capacitance sensor, an infrared sensor, and a light reflection sensor. The computer vision system may acquire and generate images of an environment and objects included therein using any combination of sensors. In some cases, the controller may determine a position and orientation of the controllable end effector within the environment using, for example, a calibration attachment coupled to the controllable end effector by identifying the calibration attachment and visual indicator(s) included thereon within a generated image.

In some embodiments, the controller may obtain and store a number of files corresponding to a number of different objects, with the files identifying parameters of objects to be picked and placed using the controllable end effector and predetermined positions to which to move the pick elements of the controllable end effector to pick and place those objects. The controller may store the files in a computer-readable storage medium available to and accessible by the controller. For each type of object to be picked and placed using the controllable end effector, the controller may obtain and store a file or portion thereof identifying the parameters of that type of object be picked and predetermined position and orientation information. The predetermined position and orientation information can include one or more of predetermined positions to which to move the pick elements of the controllable end effector to pick and place that object, a predetermined position and orientation of the controllable end effector in which the controllable end effector should be positioned relative to the object to pick up the object, a predetermined position to which to move the object (e.g., after the object is picked up), and a predetermined orientation in which the object should be oriented when moved to and placed at the predetermined position. In some cases, at least one of (i) the predetermined positions to which to move the pick elements and (ii) the predetermined position and orientation of the controllable end effector in which the controllable end effector should be positioned relative to the object to pick up the object can be selected based on the characteristics (e.g., stiffness, pliability, dimensions, mass, and porosity) of the object to be moved and the desired location(s) on the surface of the object at which the pick elements will engage with the object. In some cases, at least one of the predetermined position to which to move the object and the predetermined orientation in which the object should be oriented when moved to and placed at the predetermined position can be selected based on, for example, the requirements of a manufacturing process involving the object.

Importantly, any of the predetermined position and orientation information can be the same or different for different objects to be picked and placed. For example any of predetermined positions to which to move the pick elements of the controllable end effector to pick and place an object, a predetermined position and orientation of the controllable end effector in which the controllable end effector should be positioned relative to an object to pick up the object, a predetermined position to which to move an object (e.g., after the object is picked up), and a predetermined orientation in which the object should be oriented when moved to and placed at the predetermined position can be the same or differ between different objects. Thus, the controllable end effector provides the specific advantage of allowing for reconfiguration and customization of the positioning of pick elements, thereby allowing for different positions of the pick elements for different objects.

Some non-limiting examples of parameters of an object included in a file stored by the computer-readable storage medium accessible by the controller can include an object identifier (e.g., name, model, etc.), size, dimensions, and color. As an example, a file identifying an object and including the predetermined position and orientation information may be a comma separated value (CSV) file. Accordingly, the controller can identify and select the file corresponding to the object to be picked and placed using the controllable end effector in response to identifying the object to be picked and placed using image information acquired using the computer vision system. In some cases, the controller can receive a selection of a particular object to be picked and placed via a human machine interface (HMI), such as via a user interface and input/output device by which a user of the controllable end effector can select the object. Accordingly, the controller can identify and select the file corresponding to the object to be picked and placed using the controllable end effector in response to receiving the selection of the object via the HMI.

In some embodiments, the controller may obtain and store a number of files corresponding to a number of different objects that can be manufactured using the controllable end effector in a computer-readable storage medium, with the files identifying each of the objects to be picked and placed using the controllable end effector as part of a manufacturing process for a particular manufactured object. For each type of manufactured object, the controller can obtain and store a file or portion thereof identifying each of the objects to be picked and placed to manufacture that object, an order in which those objects are to be picked and placed, and files including the parameter, position, and orientation information for each of those objects as described herein. Accordingly, for a particular manufactured object, the controller can identify and select the file corresponding to that manufactured object, such that the controller determines the necessary information from the selected file needed to pick and place the objects that are used to form that manufactured object. As an example, based on (e.g., in response to) receiving a selection of a file corresponding to a manufactured object, the controller can identify the objects referenced by that file and select the corresponding files for each of those objects to be picked and placed as part of the manufacturing process for that manufactured object. In some cases, the controller can receive a selection of a particular manufactured object via an HMI, such as via a user interface and input/output device by which a user of the controllable end effector can select the particular manufactured object. Accordingly, the controller can identify and select the file corresponding to the particular manufactured object and related files of the objects to be picked and placed using the controllable end effector as part of manufacturing the manufactured object in response to receiving the selection of the manufactured object via the HMI. When the controller selects the file corresponding to the particular manufactured object, the controller can identify and select the files corresponding to the objects to be picked and placed using the controllable end effector and referenced by that file, such that the controller can determine the order in which the objects are to be picked and placed and the predetermined position and orientation information for each of those objects.

In some embodiments, in response to identifying and selecting a file for a next object to be picked and placed by the controllable end effector, the controller can determine, from the selected file, the predetermined positions to which to move the pick elements of the controllable end effector to pick and place those objects. The controller can cause movement of the pick elements to the determined positions at which the pick elements can engage with the surface of the object to pick and place the object. The controller can cause movement of the pick elements to the determined positions in response to selecting a file for that object and determining (e.g., reading) the positions from the file, identifying that object within the environment (e.g., using the computer vision system), and/or causing movement of the controllable end effector to a determined position and/or orientation within the environment relative to the object to be picked and placed. Accordingly, the pick elements may be moved to their determined positions at any stage of picking and placing an object.

In some embodiments, the controller may obtain and store a digital representation (e.g., a two-dimensional (2D) representation or a three-dimensional (3D) representation) of an object to be picked up and placed by the controllable end effector. Some non-limiting examples of the digital representation of the object include a computer-aided design (CAD) file identifying the object, such as a Drawing Exchange Format (DXF) file, a Standard for the Exchange of Product Data (STEP) file, a Siemens NX Part (PRT) file, and a Stereolithography (STL) file. The controller may obtain and store a number of digital representations corresponding to a number of different objects, such that the controller can cause movement and placement of different objects via the controllable end effector based on their respective digital representations. The controller may store digital representations in a computer-readable storage medium available to and accessible by the controller. In some cases, a digital representation of a particular object may be stored and/or otherwise mapped to a corresponding (e.g., CSV) file storing parameters and predetermined position and orientation information for that object. The controller may use a digital representation of an object to identify the object within the environment, determine a position and/or orientation of the controllable end effector within the environment relative to the object, determine a position to which to move the controllable end effector via the robotic element and an orientation for the controllable end effector relative to the object at that position, and/or determine positions to which to move the pick elements of the controllable end effector.

In some embodiments, the controller may cause the computer vision system to generate an image of the environment in which the controllable end effector operates. For example, a camera of the computer vision system may photograph the environment to generate a photographic image of the environment. In some cases, the controller may cause the computer vision system to generate an image of the environment to identify a particular object within the environment that is the next object to be picked and placed by the controllable end effector (e.g., as defined by the selected file for a particular manufactured object) as part of a manufacturing process for a manufactured object. In some cases, the controller may cause the computer vision system to generate an image of the environment to identify any particular object within the environment that is an object to be picked and placed by the controllable end effector (e.g., as defined by the selected file for a particular manufactured object) as part of a manufacturing process for a manufactured object. The image of the environment may include an object to be picked and placed by the controllable end effector. In some variations, the controller may cause the computer vision system to generate the image of the environment based on (e.g., in response to) determining an object to be picked and placed from the selected file for a particular manufactured object, with the selected file identifying the object to be picked and placed from a number of objects to be picked and placed. In some variations, the controller may cause the computer vision system to generate the image of the environment, with the image including a calibration attachment coupled to the controllable end effector.

In some embodiments, the computer vision system may generate and acquire the image and may provide the image to the controller. The controller may receive the image from the computer vision system. To identify an object within the image to be picked and placed, the controller may isolate one or more objects within the image and may compare each of the objects to the digital representation of the object to be picked and placed by the controllable end effector. When the digital representation of the object to be picked and placed sufficiently corresponds to an object of the one or more objects included in the image, the controller can identify that object at a position within the environment by determining the object to the picked and placed is within the environment and determine the position and orientation of that object within the environment relative to the controllable end effector. For example, using alignment software executed by the controller, the controller can compare the object within the image to the digital representation of the object, determine the object to the picked and placed is within the environment, and determine an orientation and position of that object within the environment (e.g., on x-, y-, and z-axes in Cartesian coordinate system).

In some embodiments, the controller can automatically determine a position to which to move the controllable end effector via the robotic element and an orientation for the controllable end effector relative to the object at that position. The determined position may be adjacent to (e.g., near) the object to be picked up, with the determined orientation being aligned to cause the pick elements of the controllable end effector to engage with the desired locations on the surface of the object. The controller can determine the position to which to move the controllable end effector via the robotic element and the orientation for the controllable end effector relative to the object at that position based on one or more of identifying that object as located within the environment, the determined position and orientation of that object within the environment, the predetermined position and orientation information for that object (e.g., included in a file stored in a computer-readable storage medium), and the digital representation for that object.

In some embodiments, based on (e.g., in response to) determining the position and orientation to which to move the controllable end effector via the robotic element, the controller may cause the robotic element to move the controllable end effector to the determined position (e.g., near the object to be picked up) with the determined orientation. As described herein, the controller can cause movement of the pick elements to the determined positions in response to selecting a file for that object and determining (e.g., reading) the positions from the file, identifying that object at a position within the environment (e.g., using the computer vision system), and/or causing movement of the controllable end effector to a determined position and/or orientation within the environment relative to the object to be picked and placed. When both the controllable end effector is positioned at the determined position with the predetermined position and orientation relative to the object and the pick elements are positioned at the predetermined positions for the object, the controller may cause the pick elements to engage with a surface of the object at the desired locations on the object (e.g., by activating one or more of the pick elements). For example, when the pick elements are suction cups, the controller may (i) position (e.g., lower) the controllable end effector to cause the suction cups to engage with (e.g., contact) a surface of the object and (ii) activate a suction source coupled to the suction cups and/or open valves coupled to the suction cups, thereby causing the suction cups to grip the surface of the object via suction. Based on (e.g., in response to) engagement of the pick elements with the surface of the object, controller may cause the robotic element to pick up, hold, and/or lift the object via the controllable end effector. The controllable end effector may include one or more sensors to determine whether the pick elements have engaged with a surface of the object. Some non-limiting examples of a sensor to detect engagement between the object surface and pick element(s) include a pressure sensor, camera, LiDAR sensor, ultrasonic sensor, laser depth sensor, capacitance sensor, infrared sensor, a light reflection sensor, tactile sensor, resistive sensor, or a combination thereof.

In some embodiments, while the object is picked up by the controllable end effector, the controller can cause movement of the robotic element to move the controllable end effector from the first (e.g., initial) position to a second (e.g., target) position. In some cases, the second position can be the predetermined position to which to move the object from the predetermined position and orientation information of the selected file for the object. Once the controllable end effector and object are moved to the second position and when the object is oriented with the desired orientation at the second position, the controller may cause the pick elements to disengage with (e.g., separate from) the surface of the object (e.g., by deactivating one or more of the pick elements), thereby dropping the object from the controllable end effector and placing the object at the second position with the desired orientation. For example, when the pick elements are suction cups, the controller may deactivate a suction source coupled to the suction cups and/or close valves coupled to the suction cups, thereby causing the suction cups to disengage with the surface of the object and drop the object from the controllable end effector.

In some variations, the controller may cause movement and placement of different objects via the controllable end effector using any combination of a file and a digital representation of an object and any combination of techniques as described herein. As an example, the controller may use any combination of stored files and digital representations of an object to determine the positions to which to move the pick elements to pick and place and object.

In some embodiments, the controller may use a digital representation of an object to determine positions to which to move pick elements of the controllable end effector to pick and place that object. The controller may use the digital representation of the object to determine positions to which to move pick elements of the controllable end effector in place of or in addition to a selected file corresponding to the object including predetermined position and orientation information. In some cases, the digital representation of the object may include one or more markers identifying first locations (e.g., first coordinates) on the digital representation of the object that correspond to second locations (e.g., second coordinates) on a surface of the object at which the pick elements (e.g., suction cups) of the controllable end effector are configured to engage with the object. In some cases, the second locations (e.g., second coordinates) may be selected based on the characteristics (e.g., stiffness, pliability, dimensions, mass, and porosity) of the object to be moved. In some variations, based on obtaining the digital representation, the controller may (i) automatically identify, from the included marker(s) of the digital representation, the one or more second locations (e.g., second coordinates) on the surface of the object at which the pick elements of the controllable end effector are configured to engage with the object. Based on the marker(s) identifying the one or more first locations (e.g., first coordinates) on the digital representation of the object, the controller may determine the one or more second locations (e.g., second coordinates) on the object at which the pick elements of the controllable end effector are configured to engage with the object. In some variations, the digital representation of the object may not include any markers identifying first locations (e.g., first coordinates) on the digital representation of the object.

In some embodiments, the controller may cause the computer vision system to generate an image of the environment in which the controllable end effector operates. For example, a camera of the computer vision system may photograph the environment to generate a photographic image of the environment. In some variations, the controller may cause the computer vision system to generate the image of the environment based on identifying the one or more second locations (e.g., second coordinates) on the surface of the object at which the pick elements of the controllable end effector are configured to engage with the object. The image of the environment may include the object to be picked and placed by the controllable end effector.

In some embodiments, the controller may automatically determine, based on the generated image and the determined position and orientation of that object within the environment, a position to which to move the controllable end effector via the robotic element and an orientation for the controllable end effector relative to the object at that position. The determined position may be adjacent to (e.g., near) the object to be picked up, with the determined orientation being aligned to cause the pick elements of the controllable end effector to engage with the desired, second locations on the surface of the object. In some variations, the controller may determine the position to which to move the controllable end effector by identifying the object within the image and comparing the object within the image to the digital representation of the object.

In some embodiments, the controller may automatically determine, based on the image of the object, the second locations (e.g., second coordinates) on the object at which the pick elements are configured to engage with the object. The controller may automatically determine, based on the image of the object, the second locations (e.g., second coordinates) on the surface of the object at which the pick elements are configured to engage with the object when the digital representation of the object does not include one or more markers identifying first locations (e.g., first coordinates) on the digital representation of the object that correspond to second locations (e.g., second coordinates) on a surface of the object at which the pick elements are configured to engage with the object, In some cases, the controller may determine the second locations based on a determined geometry, position, and/or orientation of the object identified within the image. For example, when a computer vision system generates an image of the environment and provides the image to the controller, the controller may detect the object within the environment and determine the desired positions of the pick elements for the controllable end effector to pick and place the object. In some cases, the controller may determine the second locations based on the characteristics (e.g., stiffness, pliability, dimensions, mass, and porosity) of the object to be moved, where the controller is configured to identify the object as corresponding to a digital representation of the object and the digital representation of the object includes indications of the characteristics (e.g., stiffness, pliability, dimensions, mass, and porosity) of the object to be moved.

In some embodiments, based on determining the position and orientation to which to move the controllable end effector via the robotic element, the controller may cause the robotic element to move the controllable end effector to the determined position (e.g., near the object to be picked up) with the determined orientation. The controller can cause movement of the pick elements to the determined positions in response to determining the second locations on the object at which the pick elements are configured to engage with the object (e.g., from a digital representation of the object), identifying that object within the environment (e.g., suing the computer vision system), and/or causing movement of the controllable end effector to a determined position and/or orientation within the environment relative to the object to be picked and placed. In some cases, the respective positions at which the pick elements are moved can correspond to the determined second locations. When both (i) the controllable end effector is positioned at the determined position with the predetermined position and orientation relative to the object and (ii) the pick elements are positioned at the desired positions for the object, the controller may cause the pick elements to engage with a surface of the object at the desired locations (e.g., at the second coordinates) on the object (e.g., by activating one or more of the pick elements). The controller may move the object as described herein based on (e.g., in response to) engagement of the pick elements with the surface of the object.

An exemplary method of use of the controllable end effector may include the following. A computing system described herein may use a CAD file to automatically reposition the geometric orientation of pick elements (e.g., suction cups) of a controllable end effector to optimize the pick and place process of an object. For example, a DXF file can be uploaded to the controller with markers indicating desired suction cup locations on the object. When a computer vision system generates an image of the environment, the controller of the end effector receives the image, detects the object within the image of the environment, determines the desired locations of the pick elements from the DXF file, and alters the geometric orientation of the pick elements of the controllable end effector to position its pick elements adjacent to (e.g., above) the desired locations.

In some embodiments, during use of the controllable end effector, the DXF file can be uploaded to a custom program (e.g., python script) available to the controller. The controller may execute the program to detect specific markers in the DXF file that indicate the desired positions on a surface of an object for the pick elements to engage with the object's surface for picking and placing the object. The program can cause sending of the positions to a table in HMI software available to the controller. The HMI software can cause sending of coordinates based on the positions to a PLC of the controller, such that the controller can cause movement of the pick elements according to the coordinates.

In some embodiments, a sensor (e.g., camera) of the computer vision system can acquire and generate an image (e.g., picture) of the environment. Camera software executed by the controller can be used to align the contours of the object to be picked and placed and identified within the image with the contours of the digital representation of the object of the DXF file to determine the orientation and position (e.g., x-, y-, and z-position in a Cartesian coordinate system) of the object with the environment. Based on the alignment, the controller can determine the position of the robotic element within the environment (e.g., real world coordinates) relative to the object.

Based on the markers of the DXF file, the controller can cause the drive elements (e.g., motors) of the controllable end effector to move the pick elements to specified positions corresponding to the desired positions on a surface of an object for the pick elements to engage with the surface for picking and placing the object. Based on the position and orientation of the object within the environment, the robotic element can move the controllable end effector to a desired position adjacent to (e.g., near and/or above) the object. The controller can then cause the robotic element to lower the controllable end effector and activate the pick elements to cause the pick elements of the controllable end effector to engage with a surface of the object and pick and place the object.

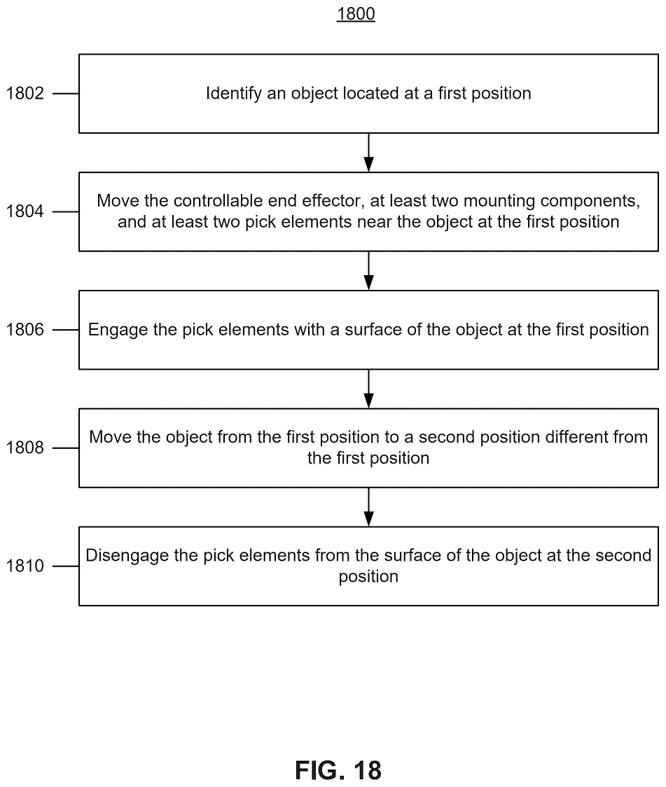

In some embodiments, referring to FIG. 18, a method 1800 for moving (e.g., translating and/or rotating) an object from a first position (e.g., first location) to a second position (e.g., second location) different from the first position using embodiments of a controllable end effector can include one or more of the following steps. In some cases, moving the object using the controllable end effector may be performed to move the object during a manufacturing process, such as during manufacturing of an article of athletic apparel or footwear. A computing system may be used to control a robotic element and a controllable end effector coupled thereto to cause performance of the method 1800, with the computing system including a controller and a computer vision system.

At step 1802, the computing system can identify an object located at a first position within an environment. The computing system can identify the object at the first position within the environment using a computer vision system and a digital representation of the object as described herein. In response to identifying the object at the first position within the environment, the computing system can determine a position near the object to which to move the controllable end effector via the robotic element and an orientation for the controllable end effector at that position relative to the object. In some cases, the computing system can determine the position and orientation to which to move the controllable end effector relative to the object using a selected file corresponding to the object and predetermined position and orientation information included therein as described herein. The predetermined position and orientation information included can include a predetermined position and predetermined orientation of the controllable end effector relative to the object. In some cases, the computing system can determine the positions to which to move the pick elements of the controllable end effector using the selected file corresponding to the object and predetermined position and orientation information included therein. In some cases, the computing system can determine the one or more locations (e.g., coordinates) on the object at which the pick elements of the controllable end effector are configured to engage with the object and the related positions to which to move the pick elements of the controllable end effector using a digital representation of the object stored by the computing system and/or an image of the object within the environment (e.g., generated by the computer vision system) as described herein. As an example, using a digital representation of the object and an image of the object within the environment, the computing system can map markers on the digital representation to the actual object imaged within the environment to determine the coordinates within the environment and on the object at which the pick elements of the controllable end effector are configured to engage with the object. As another example, using an image of the object within the environment, the computing system can identify the object and use stored characteristics (e.g., stiffness, pliability, dimensions, mass, and porosity) of the identified object to determine the coordinates within the environment and on the object at which the pick elements of the controllable end effector are configured to engage with the object. Accordingly, using one or more of predetermined locations from the selected file for the object and/or determined locations (e.g., coordinates) on the object at which the pick elements of the controllable end effector are configured to engage with the object from the digital representation of the object, the computing system can automatically determine position(s) to which to move the at least two mounting components and the pick elements coupled thereto via one or more of the drive components.

In some embodiments, identifying the object located at the first position can include one or more of the following steps. The computer system can generate, by a computer vision system, an image of the environment including the object. The computing system can identify the object within the image and compare the object within the image to a digital representation of the object. Based on the comparison, the computer system can determine the object within the image corresponds to the digital representation of the object. In response to determining the object within the image corresponds to the digital representation of the object, the computing system can thereby identify the object located at the first position.

At step 1804, the computing system can cause movement of the controllable end effector, the at least two mounting components, and the pick elements coupled thereto to the determined positions and with the determined orientation near the object at the first position. The controller of the computing system can cause movement of the controllable end effector to the determined position with the determined orientation near the object via the robotic element. The controller of the computing system can cause movement of the mounting components and the pick elements coupled thereto to the determined positions near the object via one or more drive components. Accordingly, the controller can cause (i) the robotic element to position the controllable end effector at the determined position near the object with the determined orientation and (ii) one or more of the drive components to position the mounting components and the pick elements coupled thereto to the determined positions near the object. The positions to which the mounting components and the pick elements are moved can be selected based on the characteristics of the object to the picked and placed. As an example, the positions to which the mounting components and the pick elements are moved can be based on the position, orientation, stiffness, pliability, dimensions (e.g., shape, size, thickness, etc.), mass, porosity, texture, hardness, and/or material composition of the object to be picked and placed. The positions to which the mounting components and the pick elements are moved can be predetermined and stored, for example, in a file (e.g., CSV file) corresponding to the object to be picked and placed and/or a digital representation of an object to be picked and placed. The positions to which the mounting components and the pick elements are moved can be automatically determined based on the digital representation of the object. The controller may cause movement of one or more of the pick elements independently of other pick elements coupled to the controllable end effector via one or more of the drive components to adapt to and accommodate the characteristics of the object to be picked and placed. In some cases, only a subset of the mounting components coupled to the controllable end effector and a subset of the pick elements coupled to the controllable end effector may be used to pick and place a particular object.

At step 1806, in response to movement of the controllable end effector, the at least two mounting components, and the pick elements coupled thereto to the determined positions near the object, the computing system can cause the pick elements coupled to the at least two mounting components to engage with a surface of the object at the first position. The computing system can cause the pick elements coupled to the at least two mounting components to engage with and contact a surface of the object at the determined locations on the object by (i) causing movement of the pick elements (e.g., toward the object) and/or (ii) activating the pick elements. In response to engagement of the pick elements with the surface of the object, the computing system can cause the robotic element to pick up, hold, and/or lift, via the controllable end effector, the object from the first location at a surface on which the object was positioned. The controller can confirm engagement between the pick elements with the surface of the object using one or more sensors as described herein.

At step 1808, in response to engagement between the pick elements and the object, the computing system can cause the robotic element and/or the controllable end effector to move the object from the first position to a different, second position within the environment with a desired orientation. The different, second position to which the object is moved can be determined from (e.g., be) a predetermined position for the object included in a selected file for the object. During movement of the object, the computing system can cause translation and/or rotation of the object within the environment, with the pick elements holding onto and contacting the object. The computing system can cause the object to be orientated with the desired orientation at the second position based on the movement of the robotic element, controllable end effector, and pick elements coupled thereto, such that the object has the desired orientation when placed at the second position. The desired orientation for the object at the second position can be determined from a predetermined orientation for the object included in a selected file for the object.

At step 1810, in response to movement of the object to the second position with the desired orientation, the computing system can cause the pick elements to disengage with the surface of the object, thereby releasing the object from the pick elements and placing the object on a surface at the second position. The computing system can cause the pick elements to which the object is engaged to disengage with the surface of the object at the determined locations on the object by (i) causing movement of the pick elements, (ii) causing separation between the pick elements with the surface of the object, and/or (ii) deactivating the pick elements. In response to disengagement of the pick elements from the surface of the object, the object can be released from the pick elements and the controllable end effector and placed onto a surface at the second position. In some cases, disengaging the pick elements from the surface of the object can cause the end effector to drop the object, thereby providing the object to a subsequent process.

In some cases, the method 1800 may be repeated and/or performed using a number of different controllable end effectors to manufacture an object. Accordingly, the method may be performed to move, position, and orient a number of different objects having similar or different characteristics to assemble a manufactured object such as, for example, an article of athletic apparel or footwear. As an example, a particular controllable end effector and robotic element coupled thereto can be used to manufacture a manufactured object identified by a selected file as described herein, where the selected file identifying the manufactured object references one or more individual files corresponding to the individual objects to be picked and placed to form the manufactured object or a portion thereof. When a selected file for a manufactured object references at least two files for different objects, repeating the method 1800 for a different object can involve changing positions of at least some of the mounting components and pick elements coupled thereto between the first and second repetitions of the method 1800.

The described systems and methods may be applicable to any other part of a manufacturing system. For example, based on the CAD model representative of a particular object or group of objects, a temperature of a heat press or an oven can be modified, a conveyor belt can shift directions, and a feeder can feed a different object to a robotic element.

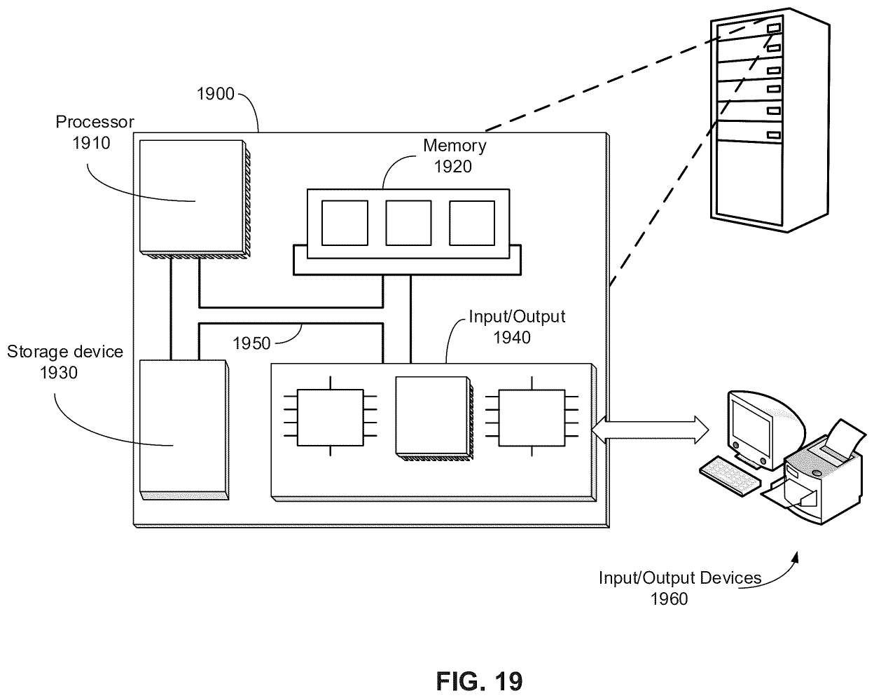

FIG. 19 is a block diagram of an example computer system 1900 that may be used in implementing the technology described herein. General-purpose computers, network appliances, mobile devices, or other electronic systems may also include at least portions of the system 1900. The system 1900 includes a processor 1910, a memory 1920, a storage device 1930, and an input/output device 1940. Each of the components 1910, 1920, 1930, and 1940 may be interconnected, for example, using a system bus 1950. The processor 1910 is capable of processing instructions for execution within the system 1900. In some implementations, the processor 1910 is a single-threaded processor. In some implementations, the processor 1910 is a multi-threaded processor. The processor 1910 is capable of processing instructions stored in the memory 1920 or on the storage device 1930.

The memory 1920 stores information within the system 1900. In some implementations, the memory 1920 is a non-transitory computer-readable medium. In some implementations, the memory 1920 is a volatile memory unit. In some implementations, the memory 1920 is a non-volatile memory unit.

The storage device 1930 is capable of providing mass storage for the system 1900. In some implementations, the storage device 1930 is a non-transitory computer-readable medium. In various different implementations, the storage device 1930 may include, for example, a hard disk device, an optical disk device, a solid-date drive, a flash drive, or some other large capacity storage device. For example, the storage device may store long-term data (e.g., database data, file system data, etc.). The input/output device 1940 provides input/output operations for the system 1900. In some implementations, the input/output device 1940 may include one or more of a network interface devices, e.g., an Ethernet card, a serial communication device, e.g., an RS-232 port, and/or a wireless interface device, e.g., an 802.11 card, a 3G wireless modem, a 4G wireless modem, or a 5G wireless modem. In some implementations, the input/output device may include driver devices configured to receive input data and send output data to other input/output devices, e.g., keyboard, printer and display devices 1960. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1930 may be implemented in a distributed way over a network, for example as a server farm or a set of widely distributed servers, or may be implemented in a single computing device.

Although an example processing system has been described in FIG. 19, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an A SIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an A SIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

Although the present invention has been described herein in detail in relation to one or more preferred embodiments, it is to be understood that this disclosure is only illustrative and exemplary of embodiments of the present invention and is made merely for the purpose of providing a full and enabling disclosure of embodiments of the invention. The foregoing disclosure is not intended to be construed to limit the present invention or otherwise exclude any such other embodiments, adaptations, variations, modifications or equivalent arrangements; embodiments of the present invention being limited only by the claims appended hereto and the equivalents thereof.

What we claim is:

1. A controllable end effector comprising:
a base component comprising a plurality of motion-defining elements;
a plurality of mounting components operatively coupled to the base component, wherein each mounting component is coupled to one of the motion-defining elements;
a plurality of drive components, wherein each drive component is configured to independently control a position of one of the mounting components; and
a plurality of pick elements configured to engage with a surface of an object, wherein each mounting component is coupled to at least one of the pick elements.

2. The controllable end effector of claim 1, wherein (i) the plurality of motion-defining elements comprises a plurality of tracks, (ii) each mounting component is coupled to one of the tracks, and (iii) each drive component is configured to independently control the position of one of the mounting components along one of the tracks.

3. The controllable end effector of claim 2, wherein the base component comprises a plate comprising a central portion and a plurality of arms connected to the central portion, wherein each of the tracks is attached along one of the arms.

4. The controllable end effector of claim 3, wherein (i) each arm extends radially from a central axis of the central portion and (ii) each track extends radially from the central axis of the central portion parallel to the respective arm to which the track is attached.

5.-6. (canceled)

7. The controllable end effector of claim 3, wherein at least one of the arms is releasably connected to the central portion.

8. The controllable end effector of claim 3, wherein the arms comprise a first bent arm and a straight arm, and wherein the first bent arm comprises a bend, a proximal end connected to the central portion, and a distal end extending parallel to the straight arm.

9. The controllable end effector of claim 8, wherein the straight arm is a nearest of the arms to the first bent arm.

10. The controllable end effector of claim 8, wherein the arms comprise a second bent arm, wherein the second bent arm comprises a bend, a proximal end connected to the central portion, and a distal end extending parallel to the straight arm, and wherein the second bent arm is disposed opposite the first bent arm with respect to the straight arm.

11.-13. (canceled)

14. The controllable end effector of claim 2, wherein at least two of the tracks are arranged in parallel.

15. (canceled)

16. The controllable end effector of claim 2, wherein at least one of the tracks comprises an arcuate track, wherein the mounting component coupled to the arcuate track is traversable about a first axis.

17. The controllable end effector of claim 2, wherein (i) each drive component is configured to translate one of the mounting components to a plurality of positions along one of the tracks and (ii) the positions comprise a first position at a first end of the track, a second position at a second end of the track, and a plurality of intermediate positions between the first position and the second position.

18. The controllable end effector of claim 2, wherein at least two of the tracks are arranged at an obtuse angle to each other.

19.-20. (canceled)

21. The controllable end effector of claim 1, wherein (i) the plurality of motion-defining elements comprises a plurality of pivot arms, (ii) each mounting component is coupled to one of the pivot arms at an end of the pivot arm, and (iii) each drive component is configured to independently control the position of one of the mounting components via one of the pivot arms.

22.-32. (canceled)

33. The controllable end effector of claim 1, wherein each drive component is configured to control, via one of the mounting components, a position of the at least one pick element coupled to the mounting component.

34.-37. (canceled)

38. The controllable end effector of claim 1, wherein at least one of the pick elements comprises at least one of: a suction cup, a suction source, a fan, a gecko gripper, a mechanical gripper, an electro-adhesion gripper, or an adhesive gripper.

39. The controllable end effector of claim 38, wherein the pick element comprises the suction cup and the suction source, and wherein the suction cup is fluidically coupled to the suction source, the controllable end effector further comprising a control element coupled to the suction cup and configured to control contact of the suction source to the object by the suction cup.

40.-41. (canceled)

42. The controllable end effector of claim 1, wherein at least a portion of one of the pick elements is configured to move from a first position to a second position along a central axis of the pick element.

43.-48. (canceled)

49. A method of moving an object during a manufacturing process, the method comprising the steps of:
identifying an object located at a first position;
moving a controllable end effector, at least two mounting components coupled to the controllable end effector, and at least two pick elements coupled to the at least two mounting components near the object;
engaging the at least two pick elements coupled to the at least two mounting components with a surface of the object;
moving, via the at least two pick elements, the object from the first position to a second position different from the first position; and
disengaging the at least two pick elements from the surface of the object.

50. The method of claim 49, wherein identifying the object located at the first position further comprises:
generating, by a computer vision system, an image of an environment comprising the object;
identifying the object within the image;
comparing the object within the image to a digital representation of the object;
determining the object within the image corresponds to the digital representation of the object; and
identifying the object located at the first position in response to determining the object within the image corresponds to the digital representation of the object.

51. The method of claim 49, wherein moving the at least two pick elements coupled to the at least two mounting components of the controllable end effector near the object further comprises:
moving the at least two pick elements to respective positions along the controllable end effector in response to identifying the object located at the first position, wherein each of the at least two pick elements is moved independently; and
moving the controllable end effector to a position near the object at the first position in response to identifying the object located at the first position.

52.-58. (canceled)
